(19) United States
(12) Patent Application Publication
(10) Pub. No.: US 2007/0206463 A1
(43) Pub. Date: Sep. 6, 2007

(54) Information Recording Medium

(76) Inventor: Kazuo Kuroda, Saitama (JP)

Correspondence Address: YOUNG & THOMPSON, 745 SOUTH 23RD STREET, 2ND FLOOR, ARLINGTON, VA, 22202, US

(21) Appl. No.: 10/592,786

(22) PCT Filed: Mar. 10, 2005
(86) PCT No.: PCT/JP05/04199

§ 371 Date: Dec. 13, 2006

(30) Foreign Application Priority Data
Mar. 15, 2004 (JP) 2004-072360

(51) Int. Cl. G11B 7/00

(52) U.S. Cl. 369/47.1

(57) ABSTRACT

An information recoding medium having a substrate (32) and a recoding layer (30) whose optical property is changed by being irradiated by a laser beam to display or erase a visible display pattern.

### TECHNICAL FIELD

The present invention relates to an information recording medium, such as an optical disc, on which recording and reproduction can be performed by irradiating it with laser light, for example.

### BACKGROUND ART

In this type of information recording medium, in order to prevent that information is mistakenly deleted during reproduction by irradiating laser light, a range of power (i.e. energy or light intensity) of laser light in which the information can be reproduced (hereinafter referred to as a “reproduction power range” in this application, as occasion demands) is set lower than a range of laser light power in which the recorded information can be deleted (hereinafter referred to as a “deleting power range” in this application, as occasion demands). Moreover, a range of laser light power in which the information can be recorded (hereinafter referred to as a “recording power range” in this application, as occasion demands) is set higher than the deleting power range. The reproduction power range, the deleting power range, and the recording power range are unique to a recording layer, and generally, this type of setting is obtained depending on the material and the film thickness of the recording layer. Then, in accordance with the recording layer, an information recording/reproducing apparatus is constructed to irradiate the laser for recording with a much higher power than that of the laser for reproduction.

On the other hand, there is also suggested a technology of deleting the information, by deteriorating the recording layer having the above-mentioned character by irradiating the laser for reproduction a plurality of times, in order to limit the number of times of the information reproduction. For example, a patent document 1 discloses a technology of deleting the recorded information, by increasing the power of the laser for reproduction of the information recording/reproducing apparatus, up to near the power of deleting the information data on the information recording medium, and by irradiating the laser for reproduction by a controlled certain number of times.

Moreover, there is also suggested a hybrid type optical disc having a recordable recording area similar to that of a recordable type optical disc, such as a CD-R and a DVD-R, and a reproduce only recording area similar to that of a reproduce only optical disc, such as a CD-ROM and a DVD-ROM, located in an area nearer the outer circumference and an area nearer the inner circumference of one optical disc, respectively.

Patent document 1: Japanese Patent Application Laying Open NO. 2001-331942

Patent document 2: Japanese Patent Application Laying Open NO. 2001-67731

### DISCLOSURE OF INVENTION

### Subject to be Solved by the Invention

However, according to the above-mentioned hybrid type optical disc, there is still a difficulty in combination with the technology of limiting the number of times of reproduction.

Moreover, according to the optical disc on which the number of times of the information reproduction is limited, there is such a technical problem that there is no way to certainly or easily know whether the optical disc is currently in a reproducible condition or in an unreproducible condition after the reproduction is performed by a predetermined number of times.

In order to solve the above-mentioned problem, it is therefore an object of the present invention to provide an information recording medium on which the number of times of reproduction can be limited and in which it is possible to certainly and easily know information about whether or not the information recording medium is in the reproducible condition.

### MEANS FOR SOLVING THE SUBJECT

The above object of the present invention can be achieved by an information recording medium provided with: a substrate; and a recording layer which is laminated on the substrate and whose optical feature is changed by being irradiated it with laser light, to thereby display or delete a visible display pattern.

According to the information recording medium of the present invention, it is possible to change the optical feature of the recording layer, by that the laser light is irradiated by an information reproducing apparatus, such as an optical disc player, for example. Here, as the “optical feature” in the present invention, various optical features can be listed, such as optical reflectance ratio, light absorption ratio, light shading ratio, refractive index, or color, color saturation, brightness of color, or the like of reflected light, transmitted light, refracted light, or the like.

As described above, in accordance with whether or not the laser light is irradiated only by a limited number of times, for example, it is possible to display or delete the visible display pattern, i.e. a visually recognizable display pattern. Thus, it is possible to enable a user to certainly or easily know the information about whether or not the information recording medium is currently in the reproducible condition, for example.

In one aspect of the information recording medium of the present invention, it is further provided with: a reproduce only area in which first record information is recorded not to be unreproducible along with a reproduction operation; and a number-of-times-of-reproduction limit area in which second record information is recorded to be unreproducible along with a predetermined number of times of reproduction operations, the recoding layer being formed in accordance with the number-of-times-of-reproduction limit area. In particular, a “number-of-times-of-reproduction limit area” is one example of the “reproduction frequency limited area” of the present invention.

According to this aspect, it is possible to reproduce the second record information recorded in the number-of-times-of-reproduction limit area corresponding to the recording layer, by the predetermined number of times, such as once or a plurality of times, by using the information reproducing apparatus, such as an optical disc player, for example. In tandem with or simultaneously with this, it is also possible to reproduce the first record information recorded in the reproduce-only area. Then, after the predetermined number of times of the reproduction, the second record information is, for example, deleted along with the predetermined number of times of reproduction operations, so that the second record information is no longer reproducible.

On the other hand, the first record information may be kept reproducible. Alternatively, the first record information may be made unreproducible by setting the second record information to be the information necessary to reproduce the first record information, such as an encryption key corresponding to the first record information encrypted, and file system information for managing the file of the first record information, for example. As described above, it is possible to relatively easily limit the number of times of reproduction of the second record information or the first and second record information. Moreover, if the first and second record information is recorded such that the second record information is necessary to reproduce the first record information, then, it is possible to restore the first and second record information to the reproducible condition, by recording again only the second record information after the second record information is reproduced only by the predetermined number of times and even the first record information is made unreproducible, because the first record information is maintained as it is. In this manner, the information recording medium can be reused.

Incidentally, in the number-of-times-of-reproduction limit area, the second record information may be able to be reproduced only once, as the predetermined number of times. Alternatively, it may be able to be reproduced a plurality of times, such as twice, three times, and four times, as the predetermined number of times. Moreover, the number of times of reproduction may be strictly limited, such as only once and only twice, for example, or the number of times of reproduction may be limited in a certain degree of range of the number of times, such as about five times and about 10 times, for example.

In addition, as the first record information, a large information data amount of contents, such as a movie, can be recorded into the reproduce only area at a time by using a stampa, so that it is possible to reduce a preparation time length per one information recording medium, and it is possible to improve its productivity.

As described above, the number of times of reproduction can be limited, and moreover, the visible display pattern which varies depending on whether or not the reproduction is ended by the limited number of times of reproduction, can be displayed or deleted. Thus, it is possible to enable a user to more certainly or easily know the information about whether or not the information recording medium is currently in the reproducible condition.

In another aspect of the information recording medium of the present invention, (i) the second record information is recorded into the number-of-times-of-reproduction limit area by forming a record mark corresponding to the second record information, and (ii) the second record information is deleted from the number-of-times-of-reproduction limit area by deleting the record mark along with the predetermined number of times of reproduction operations, and at least one of the substrate and the recording layer is formed (iii) such that a visible display pattern can be made from a difference in the optical feature between an area in which the record mark is deleted and an area in which the record mark has been absent since before the reproduction operation, in such a condition that the record mark is deleted, or (iv) such that a visible display pattern can be made from a difference in the optical feature between an area in which the record mark is present and an area in which the record mark has been absent since before the reproduction operation, in such a condition that the record mark is present.

According to this aspect, in the beginning when the second record information can be reproduced, the record mark corresponding to the second record information is formed in the recording layer laminated at least on the number-of-times-of-reproduction limit area on the substrate. After that, by deleting the record mark along with the reproduction operation, the second record information is deleted from the number-of-times-of-reproduction limit area.

Then, particularly in the present invention, in at least one of the substrate and the recording layer, the visible display pattern, such as characters and figures, like “unreproducible”, “reproductionX”, “X”, or the like, for example, can be made from the difference in the optical feature between the area in which the record mark is deleted and the area in which the record mark has been absent since before the reproduction operation, in such a condition that the record mark is deleted, after the number of times of reproduction. For example, the visible display pattern is visually recognized in such a condition that the record mark is deleted, (i) in accordance with an in-plane distribution of optical reflectance on the substrate surface, which depends on whether the recording layer is in an amorphous state or a crystalline state, or (ii) in accordance with an in-plane distribution of optical reflectance on the substrate surface, which depends on the unevenness (concave and convex) of the substrate surface which is a foundation on which the recording layer is laminated. Therefore, it is possible to display the visible display pattern of “unreproducible” or the like, which is different from a display pattern (e.g. a plane or uniform pattern) that is seen in the condition that the record mark is present before the predetermined number of times of reproduction, on the surface of the information recording medium, after the predetermined number of times of reproduction.

Alternatively, in at least one of the substrate and the recording layer, the visible display pattern, such as characters and figures, like “reproducible”, “reproduction◯”, “◯”, or the like, for example, can be made from the difference in the optical feature between the area in which the record mark is present and the area in which the record mark has been absent since before the reproduction operation, in such a condition that the record mark is present before the number of times of reproduction. Therefore, it is possible to display the visible display pattern of “reproducible” or the like, which is different from a display pattern (e.g. a plane or uniform pattern) that is seen in the condition that the record mark is deleted after the predetermined number of times of reproduction, on the surface of the information recording medium, before the predetermined number of times of reproduction.

As described above, the number of times of reproduction can be limited, and moreover, the visible display pattern which varies depending on whether or not the reproduction is ended by the limited number of times of reproduction, can be displayed or deleted. Thus, it is possible to enable a user to more certainly or easily know the information about whether or not the information recording medium is currently in the reproducible condition.

In another aspect of the information recording medium of the present invention, at least one of the substrate and the recording layer is formed (i) such that the visible display pattern can be made from the difference in the optical feature between the number-of-times-of-reproduction limit area in which the record mark is deleted and the reproduce-only area, in such a condition that the record mark is deleted, or (ii) such that the visible display pattern can be made from the difference in the optical feature between the number-of-times-of-reproduction limit area in which the record mark is present and the reproduce-only area, in such a condition that the record mark is present.

According to this aspect, in at least one of the substrate and the recording layer, the visible display pattern, such as characters and fires, like “unreproducible” or the like, can be made from the difference in the optical feature between the number-of-times-of-reproduction limit area in which the record mark is deleted and the reproduce-only area in which the record mark has been absent since before the reproduction operation, in such a condition that the record mark is deleted after the predetermined number of times of reproduction. Therefore, it is possible to display the visible display pattern of “unreproducible” or the like, on the surface of the information recording medium, after the predetermined number of times of reproduction.

Alternatively, in at least one of the substrate and the recording layer, the visible display pattern, such as characters and figures, like “reproducible” or the like, can be made from the difference in the optical feature between the number-of-times-of-reproduction limit area in which the record mark is present and the reproduce-only area in which the record mark has been absent since before the reproduction operation, in such a condition that the record mark is present before the predetermined number of times of reproduction. Therefore, it is possible to display the visible display pattern of “reproducible” or the like, on the surface of the information recording medium, before the predetermined number of times of reproduction.

In another aspect of the information recording medium of the present invention, the recording layer is formed in the reproduce-only area such that the optical feature is changed or not changed along with the reproduction operation of reproducing the first record information.

According to this aspect, the recording layer whose optical feature is changed or not changed before or after the reproduction operation, is disposed even in the reproduce-only area. For example, by forming an embossed pit, it is possible to record the first record information into the reproduce-only area, regardless of whether or not there is the recording layer. Then, if the embossed pit is formed on a groove track, for example, and the laser light is irradiated along the groove track as the reproduction operation with respect to the formed embossed pit, then, by forming, on the groove track, the recording layer in a condition having the same optical feature as that of the record mark (e.g. in a blackish condition), the optical feature is changed by the irradiation of the laser light. Alternatively, by forming, on a land track, the recording layer in a condition having the same optical feature as that of the record mark (e.g. in a blackish condition), the optical feature is changed or not changed by the irradiation of the laser light along the land track, in accordance with a light spot radius. In any case, the optical feature of the reproduce-only area may be adjusted by using the presence of the blackish recording layer until the irradiation of the laser light, for example, such that the visible display pattern can be made, after the reproduction, from the difference in the optical feature between (i) the number-of-times-of-reproduction limit area in which the record mark as the second record information is deleted and (ii) the reproduce-only area. Alternatively, the optical feature of the reproduce-only area may be adjusted by using the presence of the blackish recording layer until the irradiation of the laser light, for example, such that the visible display pattern can be made, before the reproduction, from the difference in the optical feature between (i) the number-of-times-of-reproduction limit area in which the record mark as the second record information is present and (ii) the reproduce-only area.

As described above, even with regard to the reproduce-only area, it is possible to adjust the optical feature of the reproduce-only area, by forming a so-called dummy record mark (e.g. the recording layer in the blackish condition) only for adjusting the optical feature, i.e. the dummy record mark which does not support or carry the record information, onto the land track.

In addition, even with regard to the number-of-times-of-reproduction limit area, it is possible to adjust the optical feature of the number-of-times-of-reproduction limit area, by forming a so-called dummy record mark (e.g. the recording layer in the blackish condition) only for adjusting the optical feature, i.e. the dummy record mark which does not support or carry the record information, onto the land track.

In another aspect of the information recording medium of the present invention, at least one of the substrate and the recording layer is at least partially formed (i) such that the visible display pattern can be made from the difference in the optical feature in such a condition that the record mark is deleted along with the predetermined number of times of reproduction operations, and (ii) such that the visible display pattern can not be made from the difference in the optical feature in such a condition that the record mark is present.

According to this aspect, if the predetermined number of times of reproduction operations are not performed, the visible display pattern can not be made from the difference in the optical feature. Namely, in this case, the visible display pattern cannot be seen. Such a condition can be obtained by adjusting the area in which the recording layer is formed, such that the above-mentioned optical features are equal when the record mark is present. Alternatively, it can be obtained (i) by forming the record mark on the recording layer such that the above-mentioned optical features are equal when the record mark is present, or (ii) by forming the so-called dummy record mark only for adjusting the optical feature, as described above. Alternatively, in addition to or instead of this, it can be obtained (i) by forming the embossed pit on the groove track and/or the land track such that the above-mentioned optical features are equal when the record mark is present, or (ii) by forming a so-called dummy embossed pit which is unrelated to the first record information in which the number of times of reproduction is not limited and which is only for adjusting the optical feature.

After that, in such a condition that the record mark is deleted after the predetermined number of times of reproduction, the visible display pattern, such as characters, like “unreproducible” or the like, for example, can be made from the difference in the optical feature described above. Namely, the visible display pattern which is not seen in the reproducible beginning condition, can be made visible when it becomes unreproducible after the predetermined number of times of reproduction operations. For example, if it becomes unreproducible, it looks like characters, such as “unreproducible”, visually emerge on the surface of the information recording medium.

In another aspect of the information recording medium of the present invention, at least one of the substrate and the recording layer is at least partially formed (i) such that the visible display pattern can be made from the difference in the optical feature in such a condition that the record mark is present, and (ii) such that the visible display pattern can not be made from the difference in the optical feature in such a condition that the record mark is deleted along with the predetermined number of times of reproduction operations.

According to this aspect, if the predetermined number of times of reproduction operations are performed, the visible display pattern can not be made from the difference in the optical feature. Namely, in this case, the visible display pattern cannot be seen. Such a condition can be obtained by adjusting the area in which the recording layer is formed, such that the above-mentioned optical features are equal when the record mark is deleted. Alternatively, it can be obtained (i) by forming the record mark on the recording layer such that the above-mentioned optical features are equal when the record mark is deleted, or (ii) by forming the so-called dummy record mark only for adjusting the optical feature, as described above. Alternatively, in addition to or instead of this, it can be obtained (i) by forming the embossed pit on the groove track and/or the land track such that the above-mentioned optical features are equal when the record mark is deleted, or (ii) by forming a so-called dummy embossed pit which is unrelated to the first record information in which the number of times of reproduction is not limited and which is only for adjusting the optical feature.

Before that, i.e. in such a condition that the record mark is present before the predetermined number of times of reproduction, the visible display pattern, such as characters, like “reproducible” or the like, for example, can be made from the difference in the optical feature between the area in which the record mark is present and the area in which the record mark has been absent since before the reproduction operation. Namely, the visible display pattern which is seen in the reproducible beginning condition, can be made invisible when it becomes unreproducible after the predetermined number of times of reproduction operations. For example, if it becomes unreproducible, it looks like characters, such as “reproducible”, visually disappear.

Incidentally, the above-mentioned two aspects may be combined. Namely, it is possible to combine (i) one area formed such that the visible display pattern can be made from the difference in the optical feature in the condition that the record mark is deleted and such that the visible display pattern can not be made from the difference in the optical feature in the condition that the record mark is present, and (ii) another area formed such that the visible display pattern can be made from the difference in the optical feature in the condition that the record mark is present and such that the visible display pattern can not be made from the difference in the optical feature in the condition that the record mark is deleted. By forming it in this manner, it is possible to display the visible display pattern, such as particular characters or figures, like “reproducible” or the like, for example, in a visible condition, in another area when it is reproducible, and after that, when it becomes unreproducible, it is possible to display the visible display pattern, such as particular characters or figures, like “unreproducible” or the like, for example, in a visible condition, in one area. In this case, particularly in the case of a disc-shaped information recording medium, recognition is performed as if the characters were visually changed. As this type of combination, it is possible (i) to use tracks in odd numbers to make characters or the like emerge, and (ii) to use tracks in even numbers to delete the characters or the like, for example. Alternatively, it is possible (i) to use a half circle portion of the disc-shaped information recording medium to make the characters or the like emerge, and (i) to use the remaining half circle portion to delete the characters or the like, for example. Moreover, in the case of a multilayer disc, it is possible (i) to use one recording layer to make characters or the like emerge, and (ii) to use another recording layer to delete the characters or the like, for example.

In this aspect, the optical feature may be optical reflectance ratio.

By virtue of such construction, since at least one of the substrate and the recording layer is formed such that the visible display pattern can be made from the difference in the optical feature, it is possible to display the visible display pattern excellent in visibility, relatively easily, particularly in the case of a reflective type information recording medium provided with a light reflective film, such as an aluminum film, for example between a recording film and the substrate. Namely, in this case, the reflective film is made on the substrate located on the rear of the recording layer, as viewed from the irradiation side of the laser light, as a part of the reproduction operation, for example, and by this, the information recording medium may be set as the reflective type information recording medium.

Incidentally, the optical feature is not limited to the reflectance, and may be any optical feature as long as the visible display pattern can be visible, such as light absorption ratio, light shading ratio, refractive index, or color, color saturation, brightness of color, or the like of reflected light, transmitted light, refracted light, or the like.

In this aspect, the optical feature may be refractive index.

By virtue of such construction, it is also possible to adopt a more suitable another manufacturing process, when the optical feature of the recording layer is changed, for example.

In another aspect of the information recording medium of the present invention, a concavo-convex pattern which generates the difference in the optical feature is formed on a surface of the substrate.

According to this aspect, the visible display pattern is displayed by using the concavo-convex pattern, such as the embossed pit or the like, formed on the surface of the substrate. For example, when it can be reproducible, the concavo-convex pattern and the record mark are formed such that the optical features, such as the optical reflectance, are substantially equal between an area in which the concavo-convex pattern is formed and an area in which the record mark is formed. In this manner, after that, when the record mark is deleted, the visible display pattern corresponding to the concavo-convex pattern emerges in a relatively bright (or dark) condition. Alternatively when it can not be reproducible (or when it is unreproducible), the concavo-convex pattern is formed such that the optical features, such as the optical reflectance, are substantially equal between an area in which the concavo-convex pattern is formed and an area in which the record mark is deleted. In this manner, before that, when the record mark is present, the visible display pattern corresponding to the concavo-convex pattern emerges in a relatively dark (or bright) condition, and this is deleted (or this disappear) when it becomes unreproducible.

In another aspect of the information recording medium of the present invention, the visible display pattern includes characters or figures.

According to this aspect, it is possible to make characters or figures emerge or disappear (or delete them) after the predetermined number of times of reproduction operations, and it is possible to enable a user to know an indication of unreproducibility, extremely easily. Incidentally, this is not limited to the characters or figures, and it is also possible to enable the user to know the indication of unreproducibility, by changing a design and color in accordance with a predetermined rule and standard. For example, if it becomes blackish as a whole, it may be regarded as incapable reproduction. Moreover, this can be also combined with characters or figures which are displayed regardless of whether the reproduction can be performed or cannot performed. For example, regardless of whether the reproduction can be performed or cannot performed; characters of “reproduction” may be displayed in a predetermined area on the information recording medium, and characters of “possible” or “impossible” which emerge or which are deleted (which disappear) in accordance with whether the reproduction can be performed or cannot be performed, may be displayed in a subsequent area.

In another aspect of the information recording medium of the present invention, reproduction control information necessary to reproduce the first record information recorded in the reproduce-only area is recorded in the number-of-times-of-reproduction limit area, as the second record information.

According to this aspect, as the second record information, the reproduction control information, such as a control data, an encryption key, a file system, and an address, for example, which is necessary to reproduce the first record information, is recorded, so that after the second record information is made unreproducible by deleting it, for example, it is also impossible to reproduce the first record information, such as content information. Thus, only by making a relatively small amount of the second record information unreproducible, it is possible to make even a relatively large amount of the first record information unreproducible, and it is possible to limit the number of times of reproduction with regard to the entire information recording medium, extremely efficiently. Moreover, since the relatively large amount of the first record information is maintained as it is, it is possible to reuse the entire information recording medium, extremely efficiently, by recording again the relatively small amount of the second record information once it is made unreproducible.

Incidentally, in the case of normal video contents, access to the reproduction control information, such as a file system, for example, is performed only once at the start or activation in the beginning operation. Thus, with regard to the first record information, such as video contents, recorded in the reproduce-only area, it can be reproduced a plurality of times, as many times as needed, as long as the information recording medium is not ejected.

In contrast, in the reproduce-only area, the reproduction control information necessary to reproduce the second record information recorded in the number-of-times-of-reproduction limit area may be recorded, as the first record information. In addition, for example, the second record information may be reproduced by a predetermined process (i) in which the first record information is related to the second record information and (ii-1) which is performed on the first record information, or (ii-2) which is based on the first record information. In any case, after the second record information is deleted along with the predetermined number of times of reproduction operations, the reproduction cannot be properly performed on the information recording medium.

In another aspect of the information recording medium of the present invention, the first record information is recorded in the reproduce-only area (i) such that the first record information can be reproduced by irradiating laser for reproduction as the reproduction operation and (ii) such that the first record information is not deleted, and the second record information is recorded in the number-of-times-of-reproduction limit area (iii) such that the second record information can be reproduced by the predetermined number of times by irradiating the laser for reproduction as the reproduction operation and (iv) such that the second record information is deleted by irradiating the laser for reproduction by the predetermined number of times.

According to this aspect, in the number-of-times-of-reproduction limit area, if the laser for reproduction is irradiated by an information reproducing apparatus by the predetermined number of times, which is typically once, for example, then, the second record information is deleted. For example, if a deleting laser power range, which is unique to the recording layer in which the second record information is recorded, overlaps with a reproduction laser power range, the second record information is deleted while reproduced, as described above.

In this aspect, it may be constructed such that the second record information can be recorded by irradiating laser for recording, in the number-of-times-of-reproduction limit area.

By virtue of such construction, after the information recording medium, which is made unreproducible along with the predetermined number of times of reproduction operations due to the use in an information reproducing apparatus by a user, for example, is collected and returned to a collector or a provider, the second record information can be recorded again by the irradiation of the laser for recording, performed by the collector or the like. In this manner, it is possible to relatively easily reuse the information recording medium.

In this aspect, it may be constructed such that the recording layer has such a recording feature that a reproduction power range in which the second record information can be reproduced, at least partially overlaps with a deleting power range in which the second record information can be deleted.

By virtue of such construction, the reproduction power range and the deleting power range are unique to the recording layer, and are basically determined from the material (quality of material), film thickness, groove depth, or the like of the recording layer. Therefore, on an information reproducing apparatus, such as an optical disc player, for example, if the reproduction is performed by irradiating the information recording medium with the laser light having a power in a range of overlapping between the deleting power range and the reproduction power range, as the laser for reproduction, it is possible to delete the record information while reproducing it. More specifically, if the recording layer is irradiated with the laser light having the power within the deleting power range and within the reproduction power range, wherein the both power range are unique to the recording layer, as the laser for reproduction, the optical feature (e.g. reflectance, polarization condition, or the like) of light emitted from the recording layer (e.g. typically, reflected light, or outgoing light, such as diffraction light, refracted light, and transmitted light) is changed. Thus, it is possible to reproduce the record information recorded as a pit by phase change, for example. At the same time, by the laser light irradiated, the record information recorded as the pit by the phase change is deleted.

As described above, it is possible to reproduce the record information recorded in the recording layer, only once. Moreover, it is also possible to record the record information again, by irradiating the recording layer in which the record information is deleted as described above, with the laser light having a power within the recording power range which is also unique to the recording layer and in which the record information can be recorded, as the laser for recording. As described above, it is also possible to repeat such a process that the record information is recorded as many times as needed and that this information is deleted while reproduced only once.

However, this type of recording is preferably impossible on a commercial information recording/reproducing apparatus for consumer use (e.g. an optical disc recorder), and it is preferably performed only by an information recording apparatus specially designed for this process. Namely, by virtue of such construction, for example, by recording of the collector again only a portion deleted on the user side, it can be restored to the recorded condition, relatively easily, and it is possible to prevent illegal restoration by the user.

Incidentally, in order to form the recording layer having such a recording feature that the reproduction power range and the deleting power range overlap as described above, it is only necessary to obtain the recording feature, individually and specifically by adjusting a ratio and a film thickness between a plurality of materials which constitute the recording layer, experimentally, experientially, or theoretically, or by simulation, or the like, for example. Moreover, in order to form the recording layer in a multilayer structure having the above-mentioned recording feature, it is necessary to adjust the ratio or the film thickness, experimentally or the like, in the same manner, with regard to the multilayer.

In another aspect of the information recording medium of the present invention, (i) the recording layer includes a recording layer of such a type that it is phase-changed between an amorphous state and a crystalline state, (ii) and the optical feature is at least partially defined from an area ratio between an area in which the recording layer is in the amorphous state and an area in which the recording layer is in the crystalline state, in at least one of the reproduce-only area and the number-of-times-of-reproduction limit area.

According to this aspect, it is possible to make the visible display pattern emerge or disappear (or delete it), by changing the optical feature of the recording layer, in accordance with the phase change of the recording layer, by using the area ratio of (i) the area in which the recording layer is in the amorphous state and (ii) the area in which the recording layer is in the crystalline state. For example, if the area in the amorphous state is relatively wide, the optical reflectance decreases, so that it looks dark. If the area in the amorphous state is relatively narrow, the optical reflectance increases, so that it looks bright. As a result, it is possible to display the visible display pattern which is bright or dark depending on the distribution of the area ratio.

Incidentally in the case of an optical disc, the record mark or marks constructed from so-called 8T to 11T marks are randomly located in the number-of-times-of-reproduction limit area, so that the reflectance in the substrate surface is uniform in the number-of-times-of-reproduction limit area, with regard to the information recording medium after the recording. Therefore, it is relatively easy to adjust the optical feature between the number-of-times-of-reproduction limit area and the reproduce-only area, by using the area ratio of the area in the amorphous state, on the basis of the above-mentioned reflectance.

In another aspect of the information recording medium of the present invention, (i) the recording layer includes a recording layer of such a type that it is phase-changed between an amorphous state and a crystalline state, and (ii) the optical feature is at least partially defined from a phase change ratio of a recording layer, in at least one of the reproduce-only area and the number-of-times-of-reproduction limit area.

According to this aspect, it is possible to make the visible display pattern emerge or disappear (delete it), by changing the optical feature of the recording layer, in accordance with the phase change of the recording layer, by using the phase change ratio of (i) the area in which the recording layer is in the amorphous state and (ii) the area in which the recording layer is in the crystalline state. For example, if the phase change ratio of the area in the amorphous state is relatively high, the optical reflectance decreases, so that it looks dark. If the phase change ratio of the area in the amorphous state is relatively narrow, the optical reflectance increases, so that it looks bright. As a result, it is possible to display the visible display pattern which is bright or dark depending on the distribution of the phase change ratio.

Incidentally, in the case of an optical disc, the record mark or marks constructed from so called 3T to 11T marks are randomly located in the number-of-times-of-reproduction limit area, so that the reflectance in the substrate surface is uniform in the number-of-times-of-reproduction limit area, with regard to the information recording medium after the recording. Therefore, it is relatively easy to adjust the optical feature between the number-of-times-of-reproduction limit area and the reproduce-only area, by using the change ratio of changing to the amorphous state, on the basis of the above-mentioned reflectance.

These effects and other advantages of the present invention will become more apparent from the following embodiments.

As explained above, according to the information recording medium of the present invention, it is provided with: the substrate; and the recording layer whose optical feature is changed by being irradiated it with the laser light, to thereby display or delete the visible display pattern. Thus, it is possible to limit the number of times of reproduction, and moreover, it is possible to enable a user to certainly or easily know the information about whether or not the information recording medium a is in the reproducible condition.

### BRIEF DESCRIPTION OF DRAWINGS

FIG. 1 is a substantial plan view showing the basic structure of an optical disc in a first embodiment of the information recording medium of the resent invention, the optical disc having a plurality of recording areas, in the upper part, in association with a schematic conceptual view showing a recording area structure in the radial direction in the lower part.

FIG. 2 is a graph showing one specific example of a reproduction power range, a deleting power range, and a recording power range of a recording layer, in a number-of-times-of-reproduction limit area and a reproduce-only area (or read-only area) of the optical disc in the first embodiment of the present invention.

FIG. 3 is a schematic enlarged view showing the cross section and the plane of the physical structure before reproduction of the number-of-times-of-reproduction limit area and the reproduce-only area (or read-only area) of an optical disc in a comparison example.

FIG. 4 is a schematic enlarged view showing the cross section and the plane of the physical structure before reproduction of the number-of-times-of-reproduction limit area and the reproduce-only area (or read-only area) of the optical disc in the first embodiment of the present invention.

FIG. 5 is a schematic enlarged view showing the cross section and the plane in one specific example of the physical structure after reproduction of the number-of-times-of-reproduction limit area and the reproduce-only area (or read-only area) of the optical disc in the first embodiment of the present invention.

FIG. 6 is a schematic enlarged view showing the cross section and the plane in one specific example of the physical structure after reproduction of the number-of-times-of-reproduction limit area and the reproduce-only area (or read-only area) of the optical disc in the first embodiment of the present invention.

FIG. 7 is a schematic diagram showing one specific example of transparent characters emerging after reproduction on the recording surface of the optical disc in the first embodiment of the present invention.

FIG. 8 is a schematic structure diagram showing the cross section and the plane of the physical structure before reproduction of the number-of-times-of-reproduction limit area and the reproduce-only area (or read-only area) of an optical disc in a second embodiment of the present invention.

FIG. 9 is a schematic structure diagram showing the cross section and the plane of the physical structure before reproduction of the number-of-times-of-reproduction limit area and the reproduce-only area (or read-only area) of an optical disc in a third embodiment of the present invention.

FIG. 10 is a schematic structure diagram showing the cross section and the plane of the physical structure before reproduction of the number-of-times-of-reproduction limit area and the reproduce-only area (or read-only area) of an optical disc in a fourth embodiment of the present invention.

FIG. 11 is a schematic enlarged view showing the cross section and the plane of the physical structure before reproduction of one portion and another portion of the reproduce-only area (or read-only area) of an optical disc in a fifth embodiment of the present invention.

FIG. 12 is a schematic enlarged view showing the cross section and the plane of the physical structure after reproduction of one portion and another portion of the reproduce-only area (or read-only area) of the optical disc in the fifth embodiment of the present invention.

FIG. 13 is a schematic diagram showing one specific example of transparent characters deleted after reproduction on the recording surface of the optical disc in the fifth embodiment of the present invention.

FIG. 14 is a schematic enlarged view showing the cross section and the plane of the physical structure before reproduction of one portion and another portion of the reproduce-only area (or read-only area) of an optical disc in a sixth embodiment of the present invention.

FIG. 15 is a schematic enlarged view showing the cross-section and the plane of the physical structure before reproduction of one portion and another portion of the reproduce-only area (or read-only area) of an optical disc in a seventh embodiment of the present invention.

FIG. 16 is a schematic diagram showing one specific example of transparent characters changed after reproduction on the recording surface of an optical disc in an eighth embodiment of the present invention.

FIG. 17 is a schematic enlarged view showing the cross section of an optical disc in a ninth embodiment of the present invention.

FIG. 18 is a schematic enlarged view showing the cross section of an optical disc in a tenth embodiment of the present invention.

FIG. 19 is a block diagram showing the entire structure of an information reproducing apparatus for the optical disc in the embodiments of the present invention.

### DESCRIPTION OF REFERENCE CODES

1 . . . Center hole, 10 . . . Track, 11 . . . Sector, 20 . . . Record mark, 30 . . . Recording layer, 31 . . . Reflective layer, 32 . . . Substrate, 33 . . . Protective layer, 34 (35) . . . optical-feature change film, 100 . . . Optical disc, 101 . . . Lead-in area, 102 . . . Data zone, 103 . . . Lead out area, 150 . . . Number of times-of-reproduction limit area, 160 . . . Reproduce only area, 200 . . . Information reproducing apparatus, 202 . . . Optical pickup, 203 . . . Spindle motor, 204 . . . Read amplifier, 210 . . . Sum generation circuit 211 . . . Pit data modulation circuit, 212 . . . Pit data correction circuit, 213 . . . Buffer, 214 . . . Interface, 220 . . . Push-pull signal generation circuit, 221 . . . Low pass filter, 222 . . . Servo unit, G . . . Groove track, L . . . Land track, EP . . . Embossed pit, ES . . . Embossed space

### BEST MODE FOR CARRYING OUT THE INVENTION

Hereinafter, the best mode for carrying out the present invention will be explained in each embodiment in order, with reference to the drawings.

(First to Fourth Embodiment of Information Recording Medium)

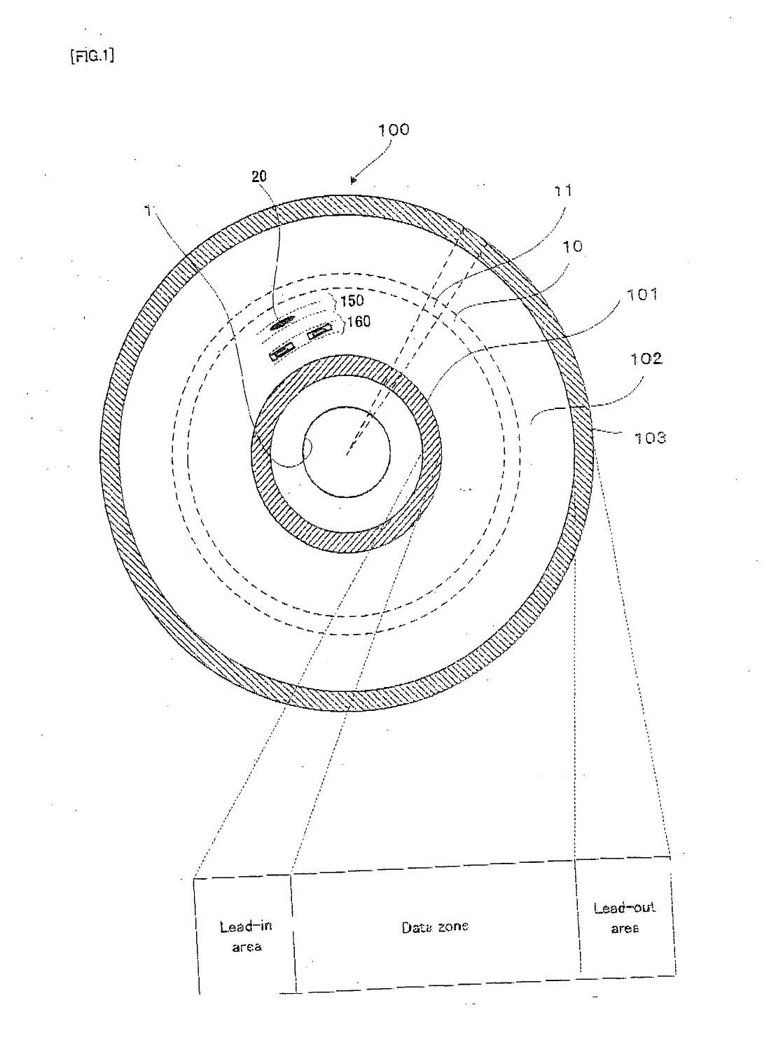

With reference to FIG. 1 to FIG. 10, the first to fourth embodiments of the information recording medium of the present invention will be explained in detail, which are embodiments of an optical disc on which transparent characters emerge.

### First Embodiment

Hereinafter, the first embodiment of the information recording medium of the present invention will be explained, with reference to FIG. 1 to FIG. 7.

Firstly, the basic structure of the optical disc in the first embodiment will be explained with reference to FIG. 1. FIG. 1 is a substantial plan view showing the basic structure of the optical disc in the first embodiment of the information recording medium of the present invention, the optical disc having a plurality of recording areas, in the upper part, in association with a schematic conceptual view showing a recording area structure in the radial direction in the lower part.

As shown in FIG. 1, an optical disc 100 has a recording surface on a disc main body with a diameter of about 12 cm, as is a DVD. On the recording surface, the optical disc 100 is provided with: a center hole 1 as the center; a lead-in area 101; a data zone 102; and a lead-out area 103, from the inner to the outer circumference. In each recording area, a track or tracks 10, such as a groove track and a land track, are alternately placed, spirally or concentrically, centered on the center hole 1, for example. On the track 10, data is divided and recorded by a unit of sector 11. The sector 11 is a data management unit by a pre-format address in which the record information is error correctable.

Incidentally, the optical disc 100 of the present invention does not necessarily have a single layer structure. It may be a two-layer single sided type, i.e., a dual layer type, or may be a two-layer double sided type, i.e., a dual layer double sided type.

The optical disc 100 in the first embodiment is constructed as a hybrid type optical disc having a combination of two types of recording areas, divided from the viewpoint of the physical characteristic, more specifically, a combination of a number-of-times-of-reproduction limit area 150 and a reproduce-only area (or read-only area) 160. In particular, a “number-of-times-of-reproduction limit area” is one example of the “reproduction frequency limited are a” of the present invention.

In the number-of-times-of-reproduction limit area 150, the record information (i.e. the “second record information” of the present invention) is recorded as a record mark, formed by the phase change of the recording layer, for example, and the record information can be reproduced by irradiating laser for reproduction only once or by a limited certain number of times. Simultaneously, the record information is deleted due to the reproduction, performed by irradiating the laser for reproduction only once or a limited certain number of times. Moreover, the record information can be recorded again, by irradiating laser for recording again, after the deletion.

On the other hand, in the reproduce-only area 160, the record information (i.e. the “first record information” of the present invention) is recorded as, an embossed pit, for example, and there is provided the characteristic of a ROM type optical disc in which the record information can be reproduced physically as many times as needed, by irradiating the laser for reproduction.

Incidentally, with regard to the arrangement of the number-of-times-of-reproduction limit area 150 and the reproduce-only area 160, they may be mixed by an extremely fine unit, such as every pit and every ECC block, for example, or they may be mixed by an extremely coarse unit, such as nearer the inner circumferential side and the outer circumferential side of the optical disc 100, for example.

As explained below, the recording area to record therein content information, such as video information and music information, shall be mainly the reproduce-only area 160, and at least one portion of the area to record therein information for controlling the reproduction of the content information shall be the number-of-times-of-reproduction limit area 150. Namely, by virtue of such construction, with respect to the optical disc 100 on which the reproduction cannot be performed any more after a predetermined number of times of reproduction, if the information is recorded again only into the number-of-times-of-reproduction limit area 150, which occupies a relatively small area, it is possible to return the optical disc 100 to the reproducible condition again. Therefore, it is useful in terms of easy recycling. However, it is arbitrary to expand the area occupied by the number-of-times-of-reproduction limit area 150, and in an extreme case, the reproduce-only area 160 may be almost or completely eliminated, and only the number-of-times-of-reproduction limit area 150 may be almost or completely provided.

As explained in detail later, in the reproduce-only area 160 and the number-of-times-of-reproduction limit area 150, it is possible to make the reflectance in the both areas almost or completely equal or different, between the case where the record mark 20 is present and the case where the record mark 20 is reproduced and simultaneously deleted. More specifically, for example, if the record mark 20 is present in the number-of-times-of-reproduction limit area 150, the reflectance of the number-of-times-of-reproduction limit area 150 and the reflectance of the reproduce-only area 160 are made almost or completely equal. On the other hand, if the record mark 20 is reproduced and simultaneously deleted in the number-of-times-of-reproduction limit area 150, the reflectance of the number-of-times-of-reproduction limit area 150 and the reflectance of the reproduce-only area 160 are made different. Alternatively, as an opposite structure, if the record mark 20 is present in the reproduce-only area 160, the reflectance of one portion of the reproduce-only area 160 and the reflectance of another portion of the reproduce-only area 160 are made different. On the other hand, for example, if the record mark 20 is reproduced and simultaneously deleted in one portion of the reproduce-only area 160, the reflectance of one portion of the reproduce-only area 160 and the reflectance of another portion of the reproduce-only area 160 are made almost or completely equal.

As described above, by making the reflectance in the both areas equal or different depending on whether or not there is the record mark 20, it is possible to visually differentiate characters and figures constructed from the number-of-times-of-reproduction limit area 150, in addition to or instead of the reproduce-only area 160, on the surface of the recording area of the optical disc 100.

Incidentally, the “record mark” in the embodiment is a concept not only including the record mark supporting or carrying the record information in which the number of times of reproduction is limited (i.e. the “second record information” of the present invention), but also including a so-called “dummy record mark”, which is only to reduce the reflectance of the recording layer before the irradiation of the laser light, i.e. before a predetermined times of reproduction operations, regardless of the record information, in the number-of-times-of-reproduction limit area 150 or the reproduce-only area 160. Namely, by using the dummy record mark, it is possible to increase the degree of freedom when characters and figures are visually differentiated and made emerge, or deleted, and it is possible to make high-contrast emerging characters. In the same manner, with regard to the embossed pit, it is a concept including a so-called dummy embossed pit, which is only to adjust the reflectance before and after the irradiation of the laser light, regardless of the record information in which the number of times of reproduction is not limited.

As described above, in the embodiment, if the dummy record mark or the dummy embossed pit only for adjusting the reflectance is formed, it is possible to make characters or the like emerge or delete them on the optical disc 100 even if the optical disc 100 has only the number-of-times-of-reproduction limit area 150 or only the reproduce-only area 160. Nevertheless, in the case of the hybrid type optical disc, making characters or the like emerge or deleting them along with the reproduction operation by the irradiation of the laser light, leads to energy saving related to the irradiation of the laser light and a shorter irradiation time length, so that it has a greater benefit in practice.

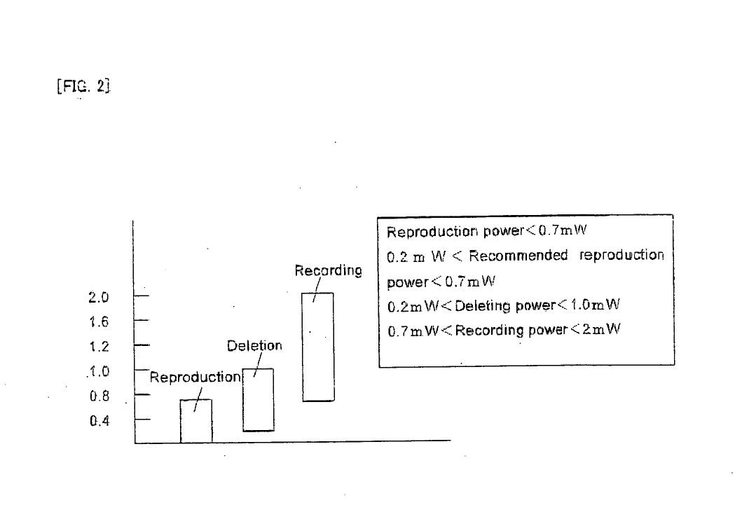

Next, with reference to FIG. 2, an explanation will be given for the physical characteristic of the recording layer, in the number-of-times-of-reproduction limit area and the reproduce-only area of the optical disc in the first embodiment of the present invention. The physical characteristic is, more specifically, a characteristic in which the record mark in which the record information is recorded, can be reproduced by irradiating the laser for reproduction, in the recording layer in the number-of-times-of-reproduction limit area and the reproduce-only area. Here, FIG. 2 is a graph showing one specific example of a reproduction power range, a deleting power range, and a recording power range of a recording layer, in the number-of-times-of-reproduction limit area and the reproduce-only area of the optical disc in the first embodiment of the present invention. In FIG. 2, the vertical axis indicates the value of the laser power by using a unit of mW (milliwatt), and the horizontal axis indicates the types of the laser of the optical disc in the example (the laser for reproduction, for deletion, and for recording, from the left, in FIG. 2).

The recording layer of the optical disc in the first embodiment of the present invention is formed such that the reproduction power range is 0.7 mW or less, as a general rule, as shown in FIG. 2. Moreover, in order to overlap the deleting power range and the reproduction power range, the recording layer may be formed such that the reproduction power range is 0.2 mW or more and 0.7 mW or less. The recording layer is formed such that the deleting power range is 0.2 mW or more and 11.0 mW or less, and the recording power range is 0.7 mW or more and 2.0 mW or less.

In this manner, in the optical disc in the first embodiment of the present invention, with regard to the number-of-times-of-reproduction limit area thereof, if the reproduction is performed by irradiating the laser light with a power in a range of overlapping the reproduction power range and the deleting power range in the first embodiment, which is recommended when the reproduction is performed on reproduce-only (or read-only) media, such as a DVD-ROM, for example, as the laser for reproduction, then, it is possible to reproduce and simultaneously delete the record information. From the viewpoint of the physical characteristic, by irradiating the laser for reproduction with a deleting power, it is possible to change a phase of the recording layer, from an amorphous state in which the record mark is formed and its reflectance is at a low level, to a crystalline state in which the reflectance is at a middle level at which the reflectance is somewhat high.

In particular, the reproduction power range and the deleting power range may overlap in a ratio of 50% or more, for example. Moreover, the deleting power range may include the reproduction power range.

Moreover, the recording power range of the recording layer of a commercially available rewritable type information recording medium, such as a DVD-R/W, or write-once type information recording medium, such as a DVD-R, is not overlapped with the recording power range of the recording layer of the optical disc in the example. Therefore, the writer of the commercially available rewritable type or write-once type information recording medium cannot perform the recording on the optical disc in the embodiment. Thus, it is possible to prevent the re-recording of the record information and illegal reproduction beyond the number of times of reproduction supposed to be limited, which is what the provider of the optical disc is not expecting. On the other hand, the collector (e.g. the provider) of the optical disc can record the record information again by irradiating the laser for recording, as shown in FIG. 2, and reuse the optical disc.

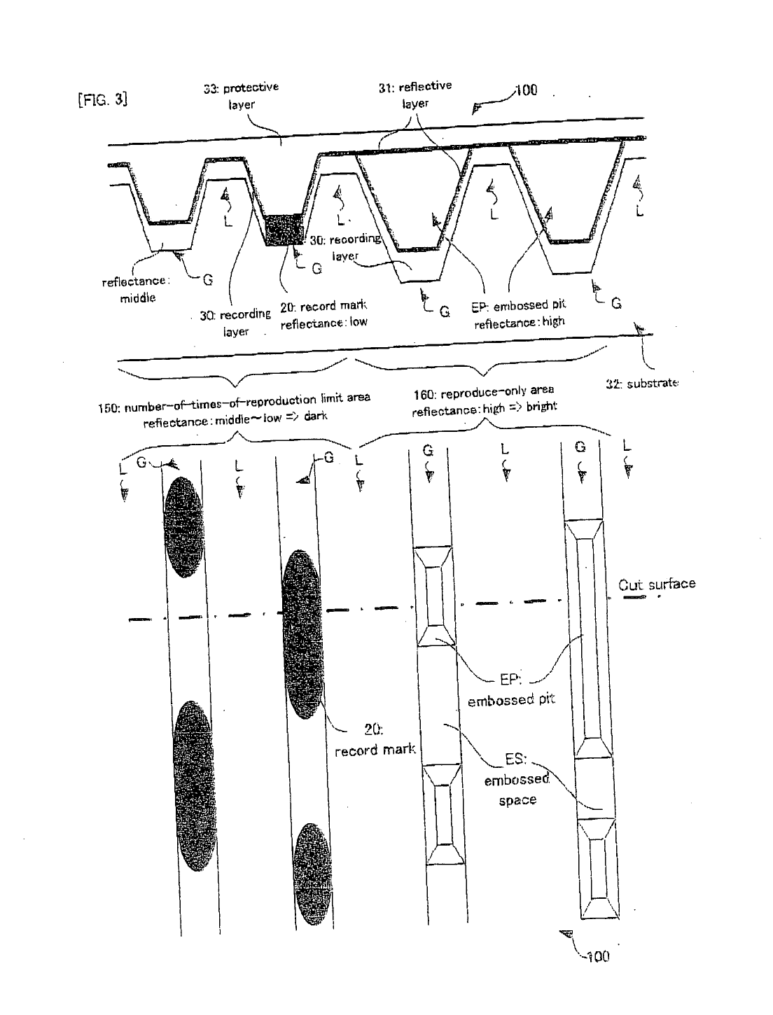

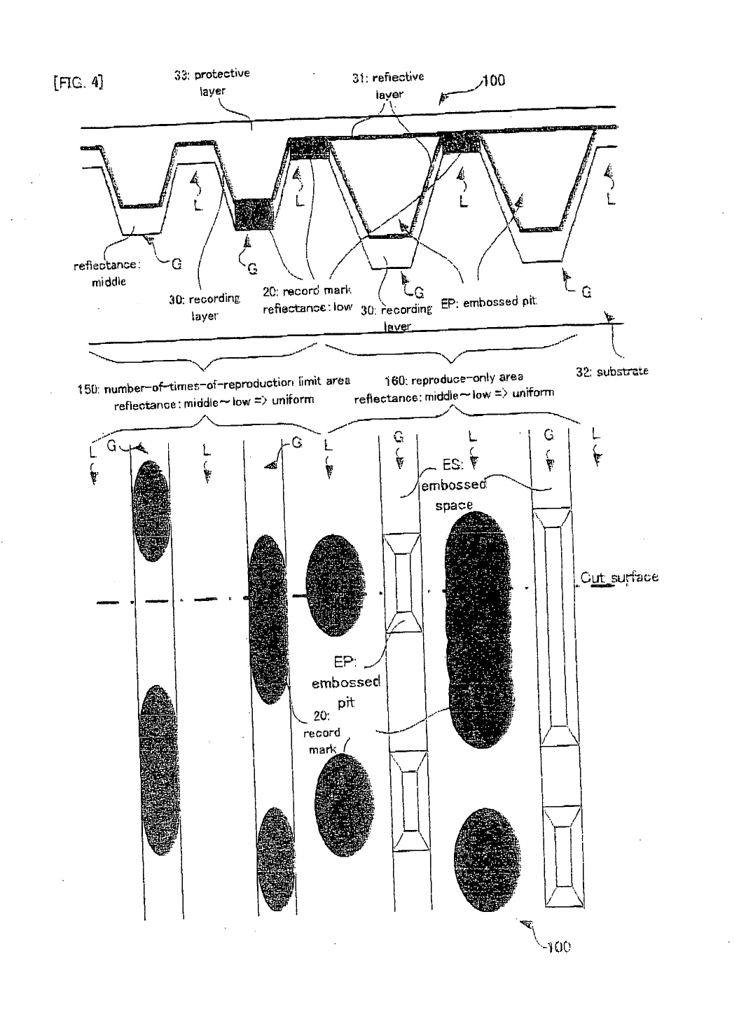

Next, with reference to FIG. 3 and FIG. 4, a detailed explanation will be given for the physical structure before reproduction of the number-of-times-of-reproduction limit area 150 and the reproduce-only area to 160 of the optical disc in the first embodiment of the present invention. FIG. 3 is a schematic enlarged view showing the cross section and the plane of the physical structure before reproduction of the number-of-times-of-reproduction limit area and the reproduce-only area (or read-only area) of an optical disc in a comparison example. FIG. 4 is a schematic enlarged view showing the cross section and the plane of the physical structure before reproduction of the number-of-times-of-reproduction limit area and the reproduce-only area (or read-only area) of the optical disc in the first embodiment of the present invention. Incidentally, the upper parts in FIG. 3 and FIG. 4 indicate the cross section of the optical disc, and the laser light is irradiated from the lower side. Moreover, the lower parts in FIG. 3 and FIG. 4 indicate the plane of the recording area of the optical disc, and a horizontal dashed dotted line indicates a cut section corresponding to the upper part in FIG. 3 and FIG. 4.

Firstly, with reference to FIG. 3 and FIG. 4, the basic physical structure of the optical disc in the first embodiment of the present invention will be explained in detail.

As shown in the upper parts of FIG. 3 and FIG. 4, the optical disc 100 in the first embodiment is provided with: a substrate 32; a recording layer 30 laminated or stacked on the substrate 32; a reflective layer 31 shown in a thick line; and a protective layer 33. Incidentally, in addition to the layers, a dielectric layer or the like may be disposed on the upper part or the lower part of the recording layer 30. Alternatively, a cover substrate or the like may be bonded on the upper layer side of the protective layer 33 made of an adhesive layer or the like.

On the entire surface of the substrate 32 (the entire surface on the upper side, in FIG. 3 and FIG. 4), a groove track G and a land track L are formed by embossing or the like. On the groove track G in the reproduce-only area 160, an embossed pit EP and an embossed space ES are formed by embossing. On the other hand, on the groove track G in the number-of-times-of-reproduction limit area 150, a record mark 20 is formed in the recording layer 30. The record mark 20 is constructed as a pit by the phase change (a pit made in black by the phase change), by irradiating the laser for recording. The reflective layer 31 is an Al (aluminum) film or the like, for example, formed directly on the recording layer 30 which is film-formed on the embossed substrate 32, or formed through a not-illustrated dielectric layer or insulating layer.

The optical disc 100 is constructed as a kind of phase change type disc provided with the recording layer 30, with regard to the number-of-times-of-reproduction limit area 150. By forming the record mark 20 in one portion of the recording layer 30, the data is recorded such that it can be deleted and reproduced. More specifically, the recording layer 30 in the crystalline state with a large reflectance is irradiated with the laser light, so that the recording layer 30 is partially melted and cooled rapidly. By this, the recording layer 30 partially becomes in the amorphous state, so that the reflectance can be reduced. In one portion of the recording layer 30 in the amorphous state as described above, the record mark 20 is formed. On the other hand, the recording layer 30 in the amorphous state is irradiated with the laser light, so that the recording layer 30 is partially melted and cooled slowly. By this, the recording layer 30 is returned to the crystalline state, to thereby regain the large reflectance. Namely, the data can be deleted.

Or the other hand, the optical disc 100 is constructed as a kind of ROM type disc provided with the embossed pit EP, independently of the presence of the recording layer 30, with regard to the reproduce-only area 160. More specifically, on the substrate 32 made of polycarbonate, the groove track G is formed as a track for guide, to lead a beam, such as the laser light. Incidentally; in the substrate 32, an area between adjacent groove tracks G is referred to as the land track L. With regard to the names of the groove track G and the land track L, it is additionally added that a concave portion viewed from the substrate 32 as a base is referred to as the groove track G, and a convex portion is referred to as the land track L. Namely, as seen from the optical pickup side: a groove corresponds to the convex portion, and a land corresponds to the concave portion.

Incidentally, with regard to the reproduce-only area 160, the presence of the embossed pit EP is a main factor to define the quantity of reflected light at the time of reproduction. Thus, even if there is the recording layer 30 and the record mark is formed on the embossed pit EP, it is possible to read the embossed pit. On the other hand, even if there is the recording layer 30 and the record mark is not formed on the embossed pit EP, it is possible to read the embossed pit in the same manner.

As described above, in the embodiment, the optical disc 100 is constructed as a kind of phase change type disc with regard to the number-of-times-of-reproduction limit area 150, and is constructed as a kind of ROM type disc with regard to the reproduce-only area 160. Then, the optical disc 100 is constructed as the hybrid type disc as a whole.

Incidentally, in the embodiment, the same recording layer 30 as in the number-of-times-of-reproduction limit area 150 may be formed in the reproduce-only area 160, and the sane recording film as in the number-of-times-of-reproduction limit area 150 may be deposited in the reproduce-only area 160. With regard to the recording layer 30 formed in the reproduce-only area 160 as described above, the information may be recorded by the phase change. Since the recording layer 30 is laminated even on the reproduce-only area 160 as described above, it is possible to reduce a difference in reflectance between the reproduce-only area 160 and the number-of-times-of-reproduction limit area 150. Moreover, if the recording layer 30 is formed on the entire surface of the substrate 32, it is not necessary to subsequently remove or exfoliate the recording layer 30 or the like, partially, so that it is useful in manufacturing. Moreover, in the initiation, by setting the entire recording layer 30 in the crystalline state, it is possible to increase the reflectance of a portion in the recording layer 30 where the record mark 20 is not recorded, more than that of a portion in the recording layer 30 where the record mark 20 is subsequently formed.

In addition, the recording layer 30 laminated even on the reproduce-only area 160 can be also used in order to reduce the reflectance of the recording layer before the irradiation of the laser light, i.e. before a predetermined times of reproduction operations, or in order to adjust the reflectance to a desired value, regardless of the record information in which the number of times of reproduction is limited. At this time, by recording the so-called “dummy record mark”, it is possible to further reduce the reflectance and adjust the reflectance to the desired value. As described above, by using the recording layer 30 laminated even on the reproduce-only area 160, and further the dummy record mark formed thereon, it is possible to make characters and figures emerge or delete them, as explained next. In the same manner, even with regard to the embossed pit, the so-called dummy embossed pit may be formed to reduce the reflectance before and after the irradiation of the laser light, regardless of the record information in which the number of times of reproduction is not limited.

In particular, this is not illustrated in FIG. 3 and FIG. 4 for convenience, but on the optical disc 100, the groove track G is preferably wobbled with a frequency corresponding to the rotational speed of the disc. The wobbled groove track a is to be formed before the optical disc 100 is shipped, as with a not-illustrated land pre-pit. Then, when the record information, i.e. information, such as image information, to be originally recorded other than pre-information, is recorded onto the optical disc 100, the optical disc 100 may be rotation-controlled at a predetermined rotational speed, by extracting the wobbling frequency of the groove track G by using an D information recording/reproducing apparatus.

Moreover, in particular, the not-illustrated land pre-pit corresponding to the pre-information may be formed in the land track L. This land pre-pit is formed generally before the optical disc 100 is shipped. Moreover, the pre-information is obtained in advance by detecting the land pre-pit, and on the basis of the pre-information obtained, the optimum output or the like of the laser light as the light for recording is set. At the same time, address information or the like indicating a location on the optical disc 100 where the record information is to be recorded, is obtained, and on the basis of the address information, the record information is recorded in a corresponding recording position.

Incidentally, in the embodiment, the groove track G and the land track L may be not present.

Moreover, the embossed pit EP on the reproduce-only area 160 and the record mark 20 formed in the number-of-times-of-reproduction limit area 150 are continuous, so that it is possible to easily perform tracking servo.

Next, with reference to FIG. 3 showing the comparison example, the operation and effect of the optical disc in the first embodiment of the present invention will be studied in advance.

As shown in FIG. 3, in the comparison example, the embossed pit EP is formed in the reproduce-only area 160. The reflectance of the reproduce-only area 160 in which the recording layer covering the embossed pit EP is in the crystalline state, is higher than that of the reproduce-only area 160 in the case where the recording layer is in the amorphous state, and than that of the reproduce-only area 160 in the case where the embossed pit is not formed. The reason that the reflectance is higher than the case where the embossed pit is not formed, as described above, is considered to be an influence of diffuse reflection or the like, by the embossed pit. The reproduce-only area 160 in which the recording layer 30 covering the embossed pit is in the crystalline state, as described above, looks bright.

On the other hand, the number-of-times-of-reproduction limit area 150 is constructed from (i) an area in which the recording layer 30 is in the crystalline state, and (ii) an area in which the recording layer 30 having the record mark 20 formed by the irradiation of the laser for recording is, in the amorphous state. In the area in the crystalline state, the reflectance is somewhat high, i.e. the reflectance is at the middle level. On the other hand, in the area in the amorphous state, the reflectance is low, i.e. the reflectance is at the low level. Therefore, the reflectance of the number-of-times-of-reproduction limit area is averaged to the middle level to the low level, so that the number-of-times-of-reproduction limit area 150 looks darker than the reproduce-only area 160 as described above.

As described above, in the hybrid type optical disc in the comparison example shown in FIG. 3, there is a difference in reflectance between (i) the number-of-times-of-reproduction limit area 150 in which the record mark 20 having the recorded record information, is formed, and (ii) the reproduce-only area 160. Thus, it is possible to visually differentiate the both areas.

As opposed to this, as shown in FIG. 4, the optical disc 100 in the first embodiment of the present invention, the embossed pit EP, the recording layer 30, and the record mark 20 are formed such that the reflectance before reproduction is almost or completely equal, in the number-of-times-of-reproduction limit area 150 in which the record mark 20 having the recorded record information, is formed, and the reproduce-only area 160. By this, it is possible not to visually differentiate the both areas. Namely, in the condition that there is the record mark 20, it is possible to uniformly provide the same brightness for the entire surface of the recording area of the optical disc 100. For example, by adjusting an area ratio and a phase change ratio in the amorphous state of the recording layer 30 between the number-of-times-of-reproduction limit area 150 and the reproduce-only area 160 in view of the presence of the embossed pit EP, it is possible to uniformly provide the same brightness for the entire surface of the recording area of the optical disc 100, as descried above.

Moreover, in the reproduce-only area 160 of the optical disc 100 in the first embodiment of the present invention, the area of the adjacent land track L may be irradiated with the laser for recording in synchronization or not in synchronization with the embossed pit EP, to thereby form the record mark 20 supporting or carrying some information or dummy information. In this case, the recording layer 30 in the area of the land track L adjacent to the embossed pit EP is phase-changed from the crystalline state in which the reflectance is at the middle level in which the reflectance is somewhat high, to the amorphous state in which the reflectance is at the low level. By this, the reproduce-only area 160 in which the recording layer 30 covering the embossed pit EP is in the crystalline state looks brighter, whereas the area of the land track L in the amorphous state looks darker. Thus, a bright and dark pattern is generated in the reproduce-only area 160, and this pattern can look gray, for example. As described above, by reducing the reflectance of the reproduce-only area 160 to the middle level or to the low level it is possible to make the reflectance of the reproduce-only area 160 almost or completely equal to the reflectance of the number-of-times-of-reproduction limit area 150.

As described above, according to the embodiment, before a predetermined times of reproduction operations, i.e. if the optical disc 100 is in the reproducible condition, it is possible to uniformly provide the same brightness for the entire surface of the recording area of the optical disc 100, by relatively adjusting (i) the presence of the record mark 20 in the recording layer 30 within the number-of-times-of-reproduction limit area 150, (ii) the presence of the embossed pit EP within the reproduce-only area 160, (iii) the presence of the recording layer 30 in the land track L or the dummy record mark 20, or the like.

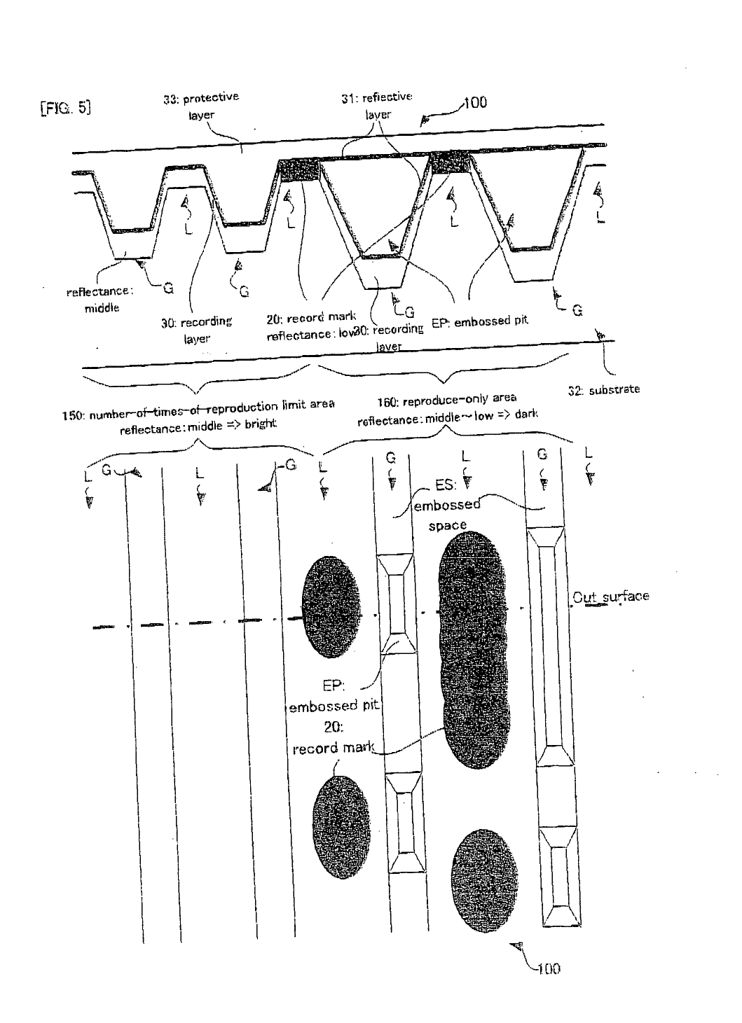

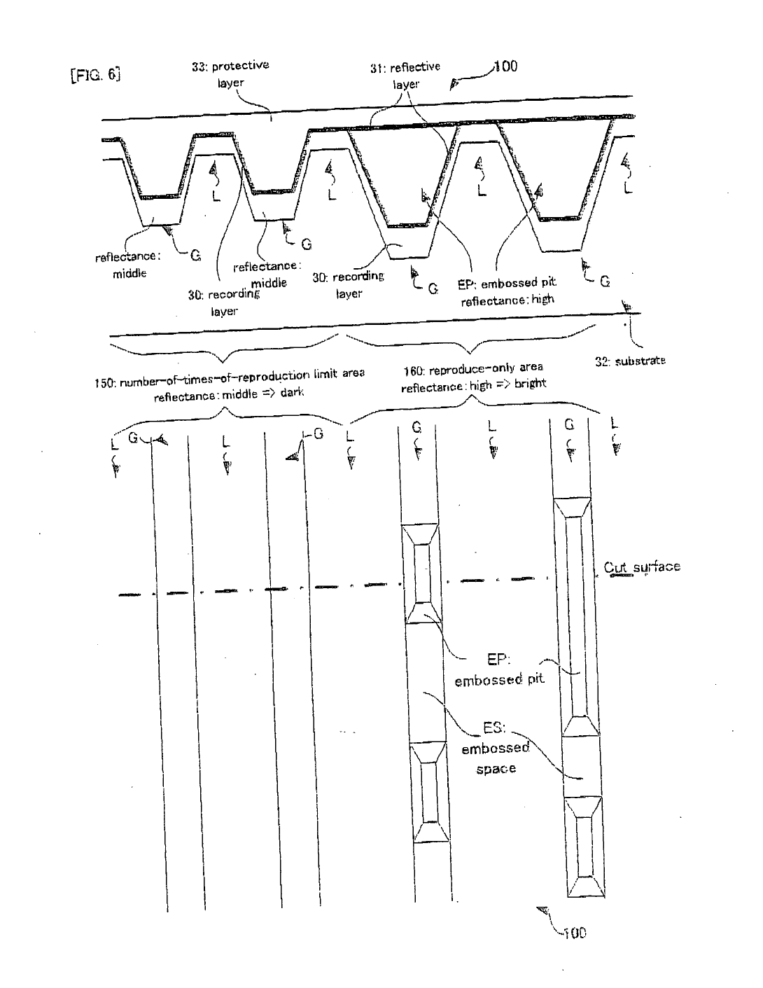

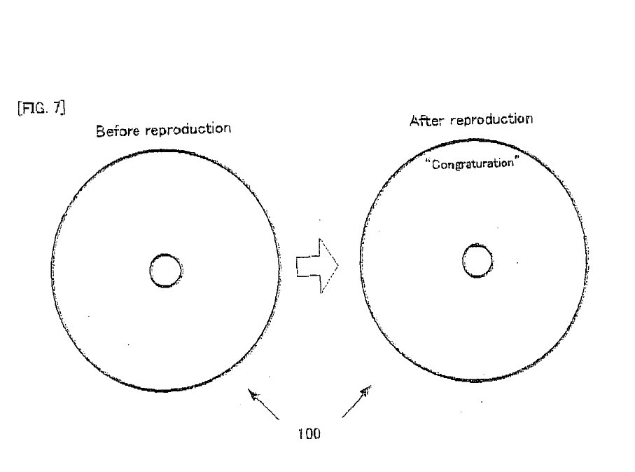

Next, with reference to FIG. 5 to FIG. 7, a detailed explanation will be given for the physical structure after reproduction of the number-of-times-of-reproduction limit area and the reproduce-only area of the optical disc in the first embodiment of the present invention. FIG. 5 is a schematic enlarged view showing the cross section and the plane in one specific example of the physical structure after reproduction of the number-of-times-of-reproduction limit area and the reproduce-only area (or read-only area) of the optical disc in the first embodiment of the present invention. FIG. 6 is a schematic enlarged view showing the cross section and the plane in another specific example of the physical structure after reproduction of the number-of-times-of-reproduction limit area and the reproduce-only area (or read-only area) of the optical disc in the first embodiment of the present invention. FIG. 7 is a schematic diagram showing one specific example of transparent characters emerging after reproduction on the recording surface of the optical disc in the first embodiment of the present invention. Incidentally, the outline of a relative positional relationship or the like in the upper parts and the lower parts shown in FIG. 5 to FIG. 7 is the same as that in FIG. 3 and FIG. 4 or the like.

In the optical disc 100 in the first embodiment of the present invention, as described above, it is possible to make the reflectance almost or completely equal between the reproduce-only area 160 and the number-of-times-of-reproduction limit area 150 before reproduction. Then, by irradiating the laser for reproduction, after the record mark 20 having the recorded record information is reproduced and simultaneously deleted, it is possible to make the reflectance different, in the number-of-times-of-reproduction limit area 150 and the reproduce-only area 160. Therefore, after reproduction, characters and figures constructed from the reproduce-only area 160 and the number-of-times-of-reproduction limit area 150, are visually differentiated and emerge on the surface of the recording area of the optical disc 100.

More specifically, as shown in FIG. 5, in the number-of-times-of-reproduction limit area 150, the record mark 20 is deleted while reproduced, by irradiating the groove track G with the laser for reproduction. On the other hand, in the reproduce-only area 160, the embossed pit EP is reproduced by irradiating the groove track G with the laser for reproduction. At this time, the reproduction in the reproduce-only area 160 is performed not to irradiate the land track L with the laser for reproduction so that the dummy record mark 20 formed on the land track L is not deleted. Then, the reflectance of the number-of-times-of-reproduction limit area 150 becomes higher than the reflectance of the reproduce-only area 160, to the extent that the record mark 20 is deleted. Namely, a relatively “bright” display pattern corresponding to the number-of-times-of-reproduction limit area 150 emerges in the reproduce-only area 160.

Alternatively, as shown in FIG. 6, in the number-of-times-of-reproduction limit area 150, the record mark 20 is deleted while reproduced, by irradiating the groove track G with the laser for reproduction. On the other hand, in the reproduce-only area 160, the embossed pit EP is reproduced by irradiating the groove track G with the laser for reproduction. At this time, the reproduction in the reproduce-only area 160 is performed to irradiate the land track L with the laser for reproduction so that the dummy record mark 20 formed on the land track L is deleted. Then, the reflectance of the number-of-times-of-reproduction limit area 150 becomes lower than the reflectance of the reproduce-only area 160, a to the extent that the embossed pit EP does not exist. Namely, a relatively “dark” display pattern corresponding to the number-of-times-of-reproduction limit area 150 emerges in the reproduce-only area 160.

As described above, it is possible to visually differentiate the number-of-times-of-reproduction limit area 150 and the reproduce-only area 160 after reproduction, and it is possible to display the bright and dark display pattern which corresponds to the arrangement of the both areas and which can be visually recognized, as shown in FIG. 7.

Namely, as shown in FIG. 7, on the optical disc 100 in the first embodiment of the present invention, for example, if it is a disc on which contents for education are recorded, or if a disc is applied to a home-use game for a personal computer, a series of data information for displaying characters, patterns, and image information or the like on a display, or for reproducing or playing music, is recorded due to the formation of the record mark. At this time, as described above, it is possible to make the reflectance almost or completely equal, between the reproduce-only area and the number-of-times-of-reproduction limit area, due to the formation of the record mark 20, before reproduction.

After that, if an entire curriculum or all the stages of the game are ended without difficulty, the record mark is reproduced and simultaneously deleted in the previous procedure. As a result, in response to a difference in reflectance between the number-of-times-of-reproduction 11t area and the reproduce-only area, transparent characters of “Omedetou/Congratulation” a or “VOID” or “Finished” emerge on the most outer circumference of the recording surface of the optical disc, for example.

Simultaneously with that, characters, patterns, and image information, such as a certificate, may be displayed on a display, or music may be played.

### Second Embodiment

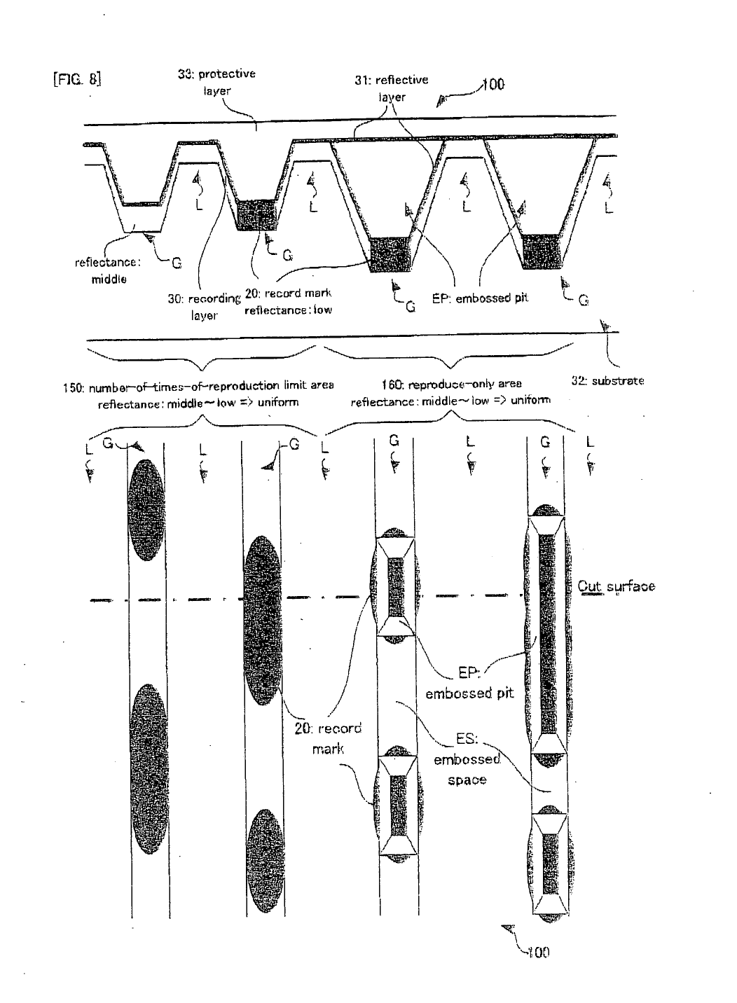

Next, with reference to FIG. 6 and FIG. 7 described above, as occasion demands, in addition to FIG. 8, a detailed explanation will be given for the physical structure before reproduction of the number-of-times-of-reproduction limit area and the reproduce-only area of an optical disc in a second embodiment of the present invention. FIG. 8 is a schematic structure diagram showing the cross section and the plane of the physical structure before reproduction of the number-of-times-of-reproduction limit area and the reproduce-only area (or read-only area) of the optical disc in the second embodiment of the present invention. Incidentally, the outline of a relative positional relationship or the like in the upper part and the lower part shown in FIG. 8 is the same as that in FIG. 3 and FIG. 4 or the like.

The optical disc 100 in the second embodiment of the present invention has the same basic physical features and structure as in the first embodiment, and the reflectance of the number-of-times-of-reproduction limit area 150 and the reflectance of the reproduce-only area 160 are almost or completely equal, due to the formation of the embossed pit EP, the recording layer 30, and the record mark 20, before reproduction. Namely, in the condition that the record mark 20 is present, it is possible to uniformly provide the same brightness for the entire surface of the recording area of the optical disc 100. For example, it is the same as the first embodiment in the point of adjusting the area ratio and the phase change ratio in the amorphous state of the recording layer 30 between the number-of-times-of-reproduction limit area 150 and the reproduce-only area 160 in view of the presence of the embossed pit EP.

More specifically, as shown in FIG. 8, in the reproduce-only area 160 of the optical disc 100 in the second embodiment of the present invention, the embossed pit EP is irradiated with the laser for recording in synchronization with the embossed pit EP, to thereby form the record mark 20 thereon. By this, the recording layer 30 covering the embossed pit EP is phase-changed from the crystalline state in which the reflectance is at the middle level at which the reflectance is somewhat high, to the amorphous state in which the reflectance is at the low level. Therefore, it is possible to reduce the reflectance of the reproduce-only area 160 constructed from rows in which there is the embossed pit EP that the recording layer 30 is in the amorphous state, from the high level to the middle level and the low level, on average.

As described above, by reducing the reflectance of the reproduce-only area 160 to the middle level to the low level, it is possible to make it almost or completely equal to the reflectance of the number-of-times-of-reproduction limit area 150 constructed from the area in the crystalline state and the area in the amorphous state in which the record mark 20 is formed.

Moreover, as a modified example of the second embodiment, by reducing the reflectance of the reproduce-only area 160 to the middle level, it is also possible to make it almost or completely equal to the reflectance of the number-of-times-of-reproduction limit area 150 constructed only from the area in the crystalline state.

As described above, the embossed pit EP with a high degree of brightness, due to the influence of diffuse reflection or the like, in which the recording layer 30 is in the crystalline state, is made in the amorphous state, By this, the degree of brightness of the row of the reproduce-only area 160 in which there are the embossed pit EP and the embossed space ES is reduced to the degree of brightness of the number-of-times-of-reproduction limit area 150. Thus, it is possible to uniformly provide the same brightness for the entire surface of the recording area of the optical disc 100.

Incidentally, in the reproduce-only area 160, the recording layer 30 located on the embossed pit EP is phase-changed from the crystalline state to the amorphous state, but because such an effect that the reflectance is low as compared to the mirror surface of the embossed pit EP is not changed, the record information recorded is not changed before or after reproduction.

The physical structure that the reflectance of the number-of-times-of-reproduction limit area and the reflectance of the reproduce-only area of the optical disc in the second embodiment of the present invention are made different after reproduction, is the same as in the first embodiment explained in FIG. 6 described above. Moreover, in the optical disc in the second embodiment of the present invention, the actual effect, such as the emerging of transparent characters or the like on the recording surface, reproduction of music, and displaying the image information, like a certificate or the like, for example, on a display, is the same as in the first embodiment explained in FIG. 7 described above.

### Third Embodiment

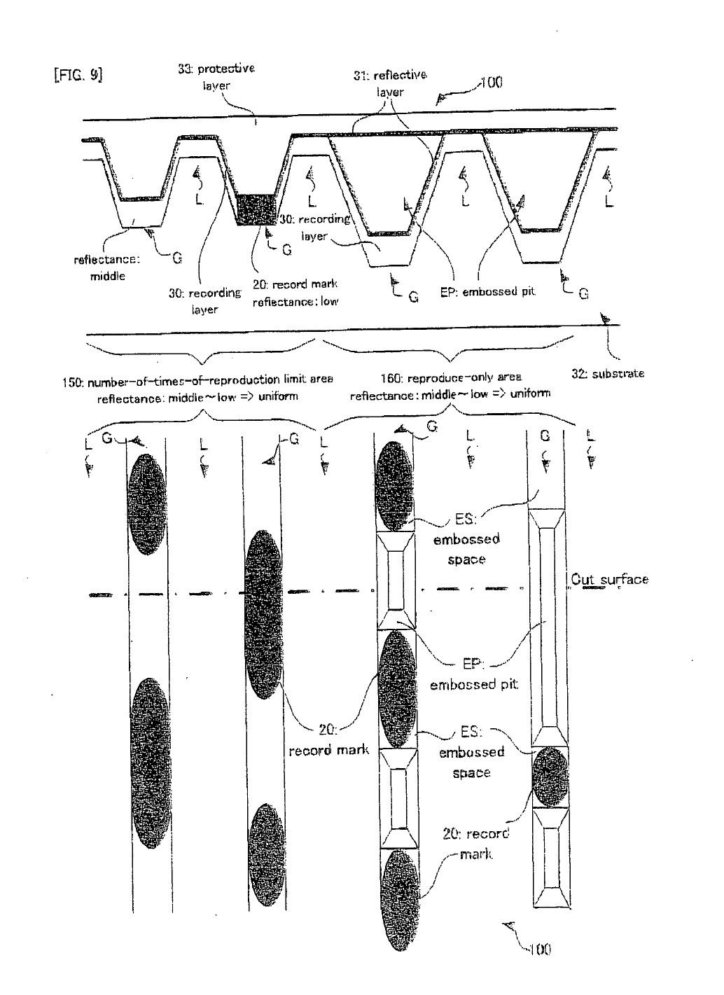

Next, with reference to FIG. 6 and FIG. 7 described above, as occasion demands, in addition to FIG. 9, a detailed explanation will be given for the physical structure before reproduction of the number-of-times-of-reproduction limit area and the reproduce-only area of an optical disc in a third embodiment of the present invention. FIG. 9 is a schematic structure diagram showing the cross section and the plane of the physical structure before reproduction of the number-of-times-of-reproduction limit area and the reproduce-only area (or read-only area) of the optical disc in the third embodiment of the present invention. Incidentally, the outline of a relative positional relationship or the like in the upper part and the lower part shown in FIG. 9 is the same as that in FIG. 3 and FIG. 4 or the like.

The optical disc 100 in the third embodiment of the present invention has the same basic physical features and structure as in the first and second embodiments, and the reflectance of the number-of-times-of-reproduction limit area 160 and the reflectance of the reproduce-only area 160 are almost or completely equal, due to the formation of the embossed pit EP, the recording layer 30, and the record mark 20, before reproduction. Namely, in the condition that the record mark 20 is present, it is possible to uniformly provide the same brightness for the entire surface of the recording area of the optical disc 100. For example, it is the same as the first embodiment in the point of adjusting the area ratio and the phase change ratio in the amorphous state of the recording layer 30 between the number-of-times-of-reproduction limit area 150 and the reproduce-only area 160 in view of the presence of the embossed pit EP.

More specifically, as shown in FIG. 9, in the reproduce-only area 160 of the optical disc 100 in the third embodiment of the present invention, the embossed pit EP is irradiated with the laser for recording in synchronization with the embossed pit EP, to thereby form the record mark 20 thereon. By this, the recording layer 30 covering the embossed pit EP is phase-changed from the crystalline state in which the reflectance is at the middle level at which the reflectance is somewhat high, to the amorphous state in which the reflectance is at the low level. Therefore, it is possible to reduce the reflectance of the reproduce-only area 160 constructed from rows in which there are the embossed space ES that the recording layer 30 is in the amorphous state and the embossed pit EP that the recording layer 30 is in the crystalline state, from the high level to the middle level and the low level, on average.

As described above, by reducing the reflectance of the reproduce-only area 160 to the middle level to the low level, it is possible to make it almost or completely equal to the reflectance of the number-of-times-of-reproduction limit area 150 constructed from the area in the crystalline state and the area in the amorphous state in which the record mark 20 is formed.

Moreover, as a modified example of the third embodiment, by reducing the reflectance of the reproduce-only area 160 to the middle level, it is also possible to make it almost or completely equal to the reflectance of the number-of-times-of-reproduction limit area 150 constructed only from the area in the crystalline state.

As described above, the embossed pit EP with a high degree of brightness, due to the influence of diffuse reflection or the like, in which the recording layer 30 is in the crystalline state, and the embossed space ES in which the recording layer is in the amorphous state, are alternately arranged. By this, the degree of brightness of the row of the reproduce-only area 160 in which there are the embossed pit EP and the embossed space ES is reduced to the degree of brightness of the number-of-times-of-reproduction limit area 150. Thus, it is possible to uniformly provide the same brightness for the entire surface of the recording area of the optical disc 100.

The physical structure that the reflectance of the number-of-times-of-reproduction limit area and the reflectance of the reproduce-only area of the optical disc in the third embodiment of the present invention are made different after reproduction, is the same as in the first embodiment explained in FIG. 6 described above. Moreover, in the optical disc in the third embodiment of the present invention, the actual effect, such as the emerging of transparent characters or the like on the recording surface, reproduction of music, and displaying the image information, like a certificate or the like, for example, on a display, is the same as in the first and second embodiments explained in FIG. 7 described above.

### Fourth Embodiment

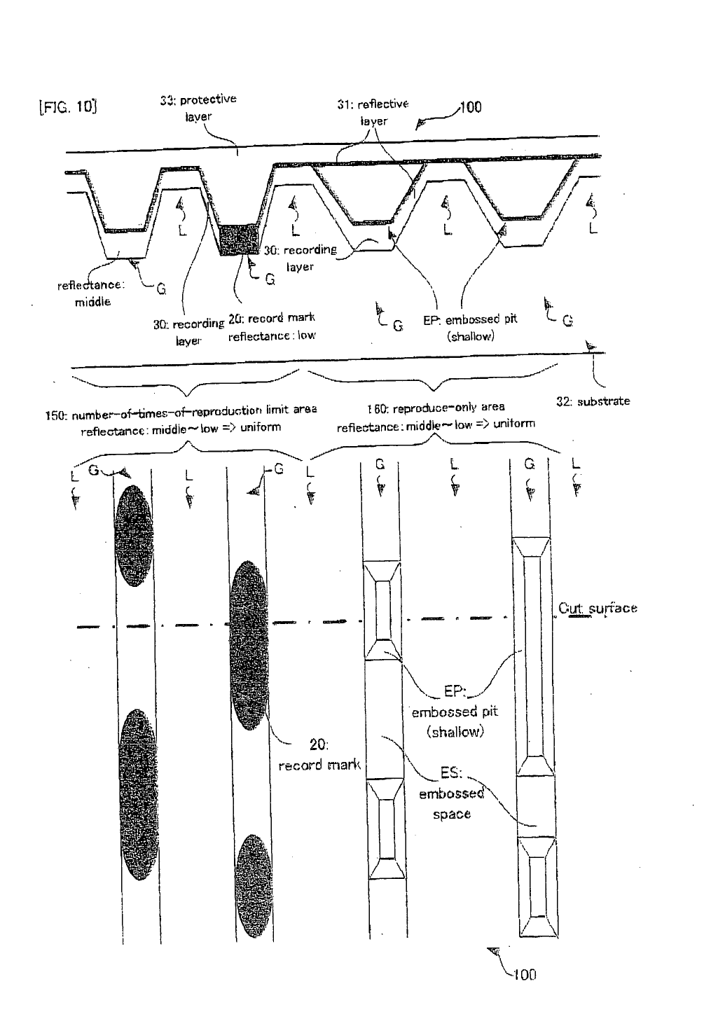

Next, with reference to FIG. 6 and FIG. 7 described above, as occasion demands, in addition to FIG. 10, a detailed explanation will be given for the physical structure before reproduction of the number-of-times-of-reproduction limit area and the reproduce-only area of an optical disc in a fourth embodiment of the present invention. FIG. 10 is a schematic structure diagram showing the cross section and the plane of the physical structure before reproduction of the number-of-times-of-reproduction limit area and the reproduce-only area (or read-only area) of the optical disc in the fourth embodiment of the present invention Incidentally, the outline of a relative positional relationship or the like in the upper part and the lower part shown in FIG. 10 is the same as that in FIG. 3 and FIG. 4 or the like.

The optical disc 100 in the fourth embodiment of the present invention has the same basic physical features and structure as in the first to third embodiments, and the reflectance of the number-of-times-of-reproduction limit area 150 and the reflectance of the reproduce only area 160 can be made almost or completely equal, by forming the recording layer 30 and the record mark 20, and by adjusting the depth of the embossed pit EP, before reproduction. Namely, in the condition that the record mark 20 is present, it is possible to uniformly provide the same brightness for the entire surface of the recording area of the optical disc 100. For example, it is the same as the first embodiment in the point of adjusting the area ratio and the phase change ratio in the amorphous state of the recording layer 30 between the number-of-times-of-reproduction limit area 150 and the reproduce-only area 160 in view of the presence of the embossed pit EP.

More specifically, as shown in FIG. 10, in the reproduce-only area 160 of the optical disc 100 in the fourth embodiment of the present invention, interference or the like is caused by reducing the depth of the embossed pit EP and by adjusting the length of a going and returning optical path, to thereby reduce the degree of reflection. Therefore, it is possible to reduce the reflectance of the reproduce-only area 160 constructed from rows in which there is the embossed pit EP, from the high level to the middle level and the low level, on average.

As described above, by reducing the reflectance of the reproduce-only area 160 to the middle level to the low level, it is possible to make it almost or completely equal to the reflectance of the number-of-times-of-reproduction limit area 150 constructed from the area in the crystalline state and the area in the amorphous state in which the record mark or the like is formed.

As described above, the depth of the embossed pit EP with a high degree of brightness, due to the influence of diffuse reflection or the like, is reduced. By this, the degree of brightness of the row of the reproduce-only area 160 in which there are the embossed pit EP and the embossed space ES is reduced to the degree of brightness of the number-of-times-of-reproduction limit area 150. Thus, it is possible to uniformly provide the same brightness for the entire surface of the recording area of the optical disc 100.

The physical structure that the reflectance of the number-of-times-of-reproduction limit area and the reflectance of the reproduce-only area of the optical disc in the fourth embodiment of the present invention are made different after reproduction, is the same as in the first embodiment explained in FIG. 6 described above. The reflectance of the reproduce-only area 160 is the middle level to the low level; however, the reproduce-only area 160 is relatively “brighter” than the number-of-times-of-reproduction limit area 150 in which the record mark 20 is not present. Moreover, in the optical disc in the fourth embodiment of the present invention, the actual effect, such as the emerging of transparent characters or the like on the recording surface, reproduction of music, and displaying the image information, like a certificate or the like, for example, on a display, is the same as in the first, second, and third embodiments explained in FIG. 7 described above.

(Fifth to Seventh Embodiments of Information Recording Medium)

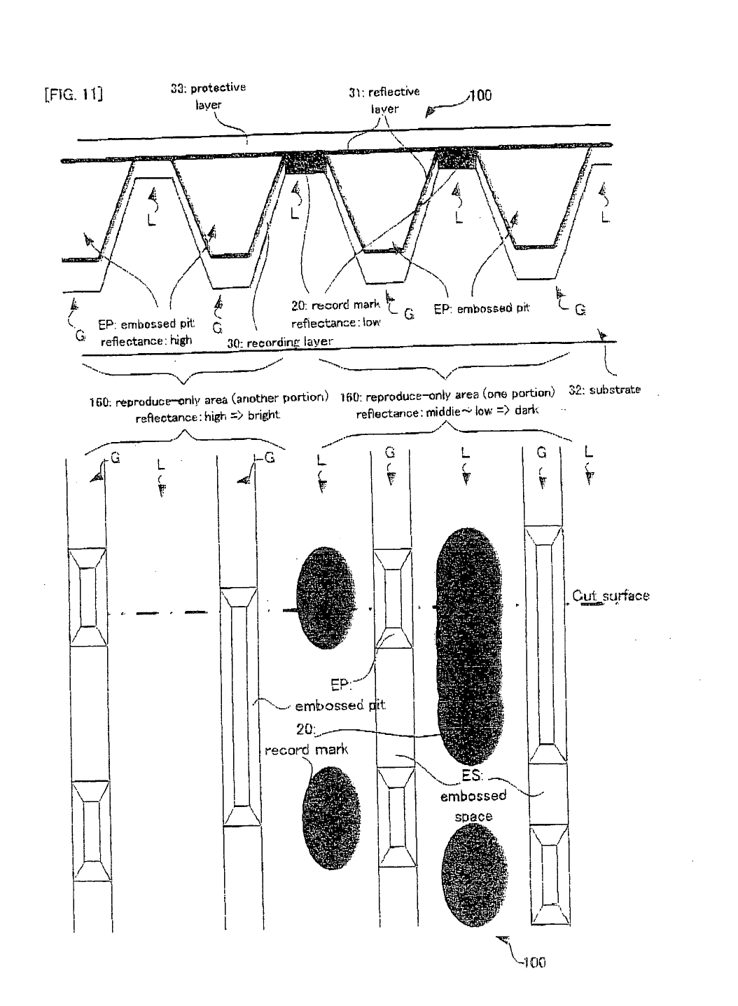

Next, with reference to FIG. 11 to FIG. 15, a detailed explanation will be given for fifth to seventh embodiments of the optical disc on which transparent characters are deleted, associated with the information recording medium of the present invention. Particularly, in the embodiments, it is constructed only from the reproduce-only area, for example.

### Fifth Embodiment

Firstly, with reference to FIG. 11, a detailed explanation will be given for the physical structure before reproduction of one portion and another portion of the reproduce-only area 160 of the optical disc 100 in the fifth embodiment of the present invention. FIG. 11 is a schematic enlarged view showing the cross section and the plane of the physical structure before reproduction of one portion and another portion of the reproduce-only area (or read-only area) of the optical disc in the fifth embodiment of the present invention. Incidentally, the outline of a relative positional relationship or the like in the upper part and the lower part shown in FIG. 11 is the same as that in FIG. 3 and FIG. 4 or the like.

The optical disc 100 in the fifth embodiment of the present invention has the same basic physical features and structure as in the first to fourth embodiments, and the reflectance of one portion of the reproduce-only area 160 and the reflectance of another portion of the reproduce-only area 160 are made different, depending on whether or not there is the record mark 20 in the area of the land track L, for example, before reproduction. Thus, in the case of the reproducible condition, characters and figures constructed from one portion and another portion of the reproduce-only area 160 are visually differentiated and emerge on the surface of the recording area of the optical disc 100

The detailed explanations about the physical structure to reduce the reflectance of one portion of the reproduce-only area 160 to the middle level to the low level, and about the adjustment of the reflectance, are the same as those of the reproduce-only area 160 in the first embodiment referred to FIG. 4.

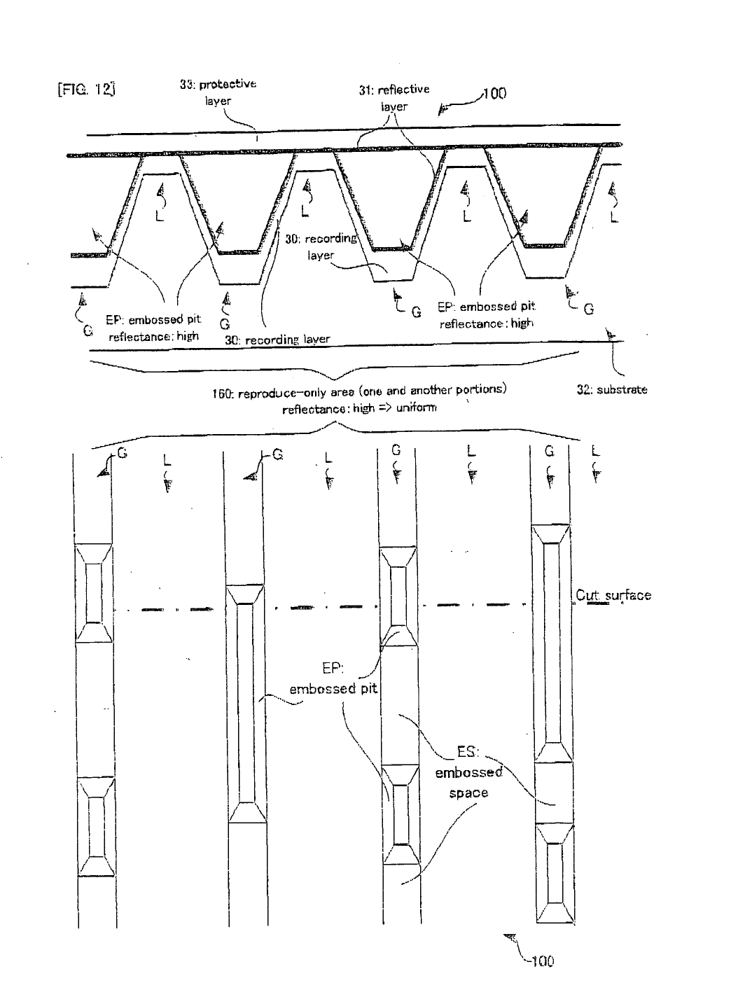

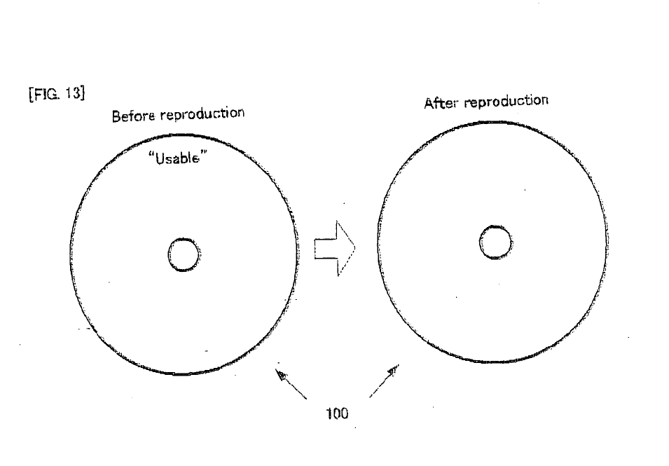

Next, with reference to FIG. 11 as occasion demands, in addition to FIG. 12 and FIG. 13, a detailed explanation will be given for the physical structure after reproduction of one portion and another portion of the reproduce-only area of the optical disc in the fifth embodiment of the present invention. FIG. 12 is a schematic enlarged view showing the cross section and the plane of the physical structure after reproduction of one portion and another portion of the reproduce-only area (or read-only area) of the optical disc in the fifth embodiment of the present invention. FIG. 13 is a schematic diagram showing one specific example of transparent characters deleted after reproduction on the recording surface of the optical disc in the fifth embodiment of the present invention. Incidentally, the outline of a relative positional relationship or the like in the upper part and the lower part shown in FIG. 12 and FIG. 13 is the same as that in FIG. 3 and FIG. 4 or the like.

On the optical disc 100 in the fifth embodiment of the present invention, for example, if it is a disc on which contents for education are recorded, or if it is applied to a home-use game for a personal computer, a series of data information for displaying characters, patterns, and image information or the like on a display, or for reproducing or playing music, is recorded due to the formation of the record mark. At this time, as shown in FIG. 11, transparent characters of “usable” emerge on the recording surface of the optical disc, due to a difference in reflectance between one portion and another portion of the reproduce-only area, caused by the formation of the record mark, before reproduction.

After that, if an entire curriculum or all the stages of the game are ended without difficulty, as shown in FIG. 12, the record mark 20 is reproduced and simultaneously deleted in the previous procedure. As a result, the difference in reflectance between one portion and another portion of the reproduce-only area 160 is almost or completely eliminated. In response to this, the transparent characters disappear from the recording surface of the optical disc, as shown in FIG. 13.

Simultaneously with that, characters, patterns, and image information, such as a certificate, may be displayed on a display, or music may be played.

### Sixth Embodiment

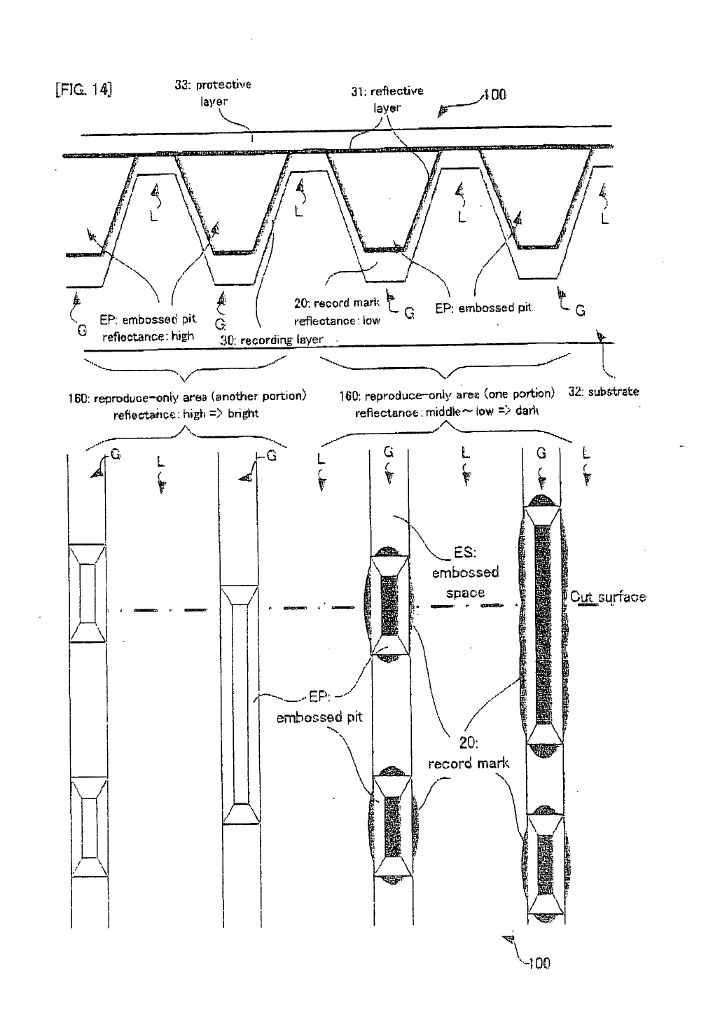

Next, with reference to FIG. 14, a detailed explanation will be given for the physical structure before reproduction of one portion and another portion of the reproduce-only area 160 of an optical disc in a sixth embodiment of the present invention. FIG. 14 is a schematic enlarged view showing the cross section and the plane of the physical structure before reproduction of one portion and another portion of the reproduce-only area (or read-only area) of the optical disc in the sixth embodiment of the present invention. Incidentally, the outline of a relative positional relationship or the like in the upper part and the lower part shown in FIG. 14 is the same as that in FIG. 3 and FIG. 4 or the like.

The optical disc 100 in the sixth embodiment of the present invention has the same basic physical features and structure as in the first to fifth embodiments, and the reflectance of one portion of the reproduce-only area 160 and the reflectance of another portion of the reproduce-only area 160 can be made different, depending on whether or not there is the record mark 20, before reproduction. Thus, characters and figures constructed from one portion and another portion of the reproduce-only area 160 are visually differentiated and emerge on the surface of the recording area of the optical disc 100.

The detailed explanations about the physical structure to reduce the reflectance of one portion of the reproduce-only area 160 to the middle level to the low level, and about the adjustment of the reflectance, are the same as those of the reproduce-only area 160 in the second embodiment referred to FIG. 8.

As described above, by reducing the reflectance of one portion of the reproduce-only area 160 to the middle level to the low level, it is possible to make it different from another portion of the reproduce-only area 160 in which the reflectance is at a high level.

The physical structure that the reflectance of one portion of the reproduce-only area and the reflectance of another portion of the reproduce-only area of the optical disc in the sixth embodiment of the present invention are made equal by deleting the record mark 20 after reproduction, is the same as in the fifth embodiment explained in FIG. 12 described above. Moreover, in the optical disc in the sixth embodiment of the present invention, the actual effect, such as the emerging of transparent characters or the like on the recording surface, reproduction of music, and displaying the image information, like a certificate or the like, for example, on a display, is the same as in the fifth embodiment explained in FIG. 13 described above.

### Seventh Embodiment

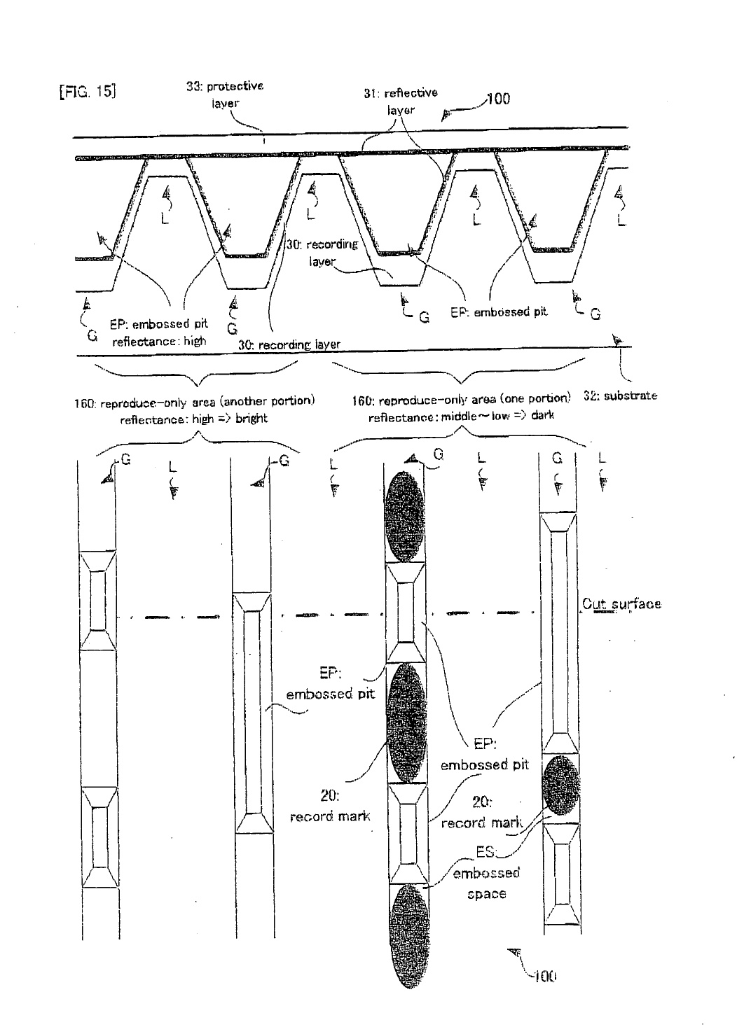

Next, with reference to FIG. 15, a detailed explanation will be given for the physical structure before reproduction of one portion and another portion of the reproduce-only area 160 of an optical disc in a seventh embodiment of the present invention FIG. 15 is a schematic enlarged view showing the cross section and the plane of the physical structure before reproduction of one portion and another portion of the reproduce-only area (or read-only area) of the optical disc in the seventh embodiment of the present invention. Incidentally, the outline of a relative positional relationship or the like in the upper part and the lower part shown in FIG. 15 is the same as that in FIG. 3 and FIG. 4 or the like.

The optical disc 100 in the seventh embodiment of the present invention has the same basic physical features and structure as in the first to sixth embodiments, and the reflectance of one portion of the reproduce-only area 160 and the reflectance of another portion of the reproduce-only area 160 can be made different, depending on whether or not there is the record mark 20, before reproduction. Thus, characters and figures constructed from one portion and another portion of the reproduce-only area 160 are visually differentiated and emerge on the surface of the recording area of the optical disc 100.

The detailed explanations about the physical structure to reduce the reflectance of one portion of the reproduce-only area 160 to the middle level to the low level, and about the adjustment of the reflectance, are the same as those of the reproduce-only area 160 in the third embodiment referred to FIG. 9.

As described above, by reducing the reflectance of one portion of the reproduce-only area 160 to the middle level to the low level, it is possible to make it different from another portion of the reproduce-only area 160 in which the reflectance is at the high level.

The physical structure that the reflectance of one portion of the reproduce-only area and the reflectance of another portion of the reproduce-only area of the optical disc in the seventh embodiment of the present invention are made equal by deleting the record mark 20 after reproduction, is the same as in the fifth embodiment explained in FIG. 12 described above. Moreover, in the optical disc in the seventh embodiment of the present invention, the actual effect, such as the emerging of transparent characters or the like on the recording surface, reproduction of music, and displaying the image information, like a certificate or the like, for example, on a display, is the same as in the fifth embodiment explained in FIG. 13 described above.

### Eighth Embodiment

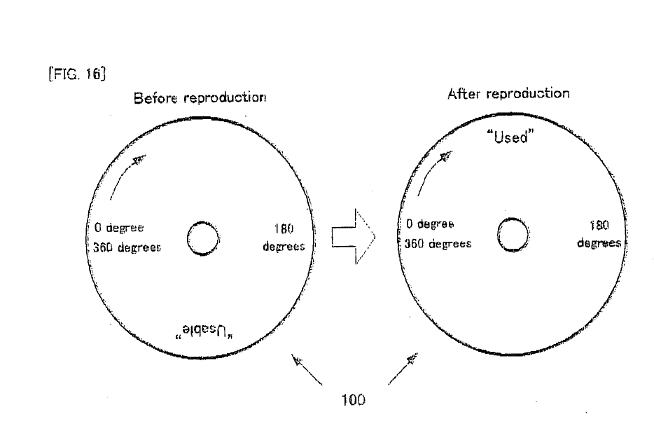

Next, with reference to FIG. 16, a detailed explanation will be given for the case where transparent characters on the recording surface are changed after reproduction, as one specific example of an optical disc in an eighth embodiment of the present invention. FIG. 16 is a schematic diagram showing one specific example of transparent characters changed after reproduction on the recording surface of the optical disc in the eighth embodiment of the present invention.

The optical disc 100 in the eighth embodiment of the present invention has the same basic physical features and structure as in the first to seventh embodiments. By using the first, second, third, or fourth embodiment of the present invention, transparent characters of “used” or the like, for example, are made emerge on the surface of the recording area at 0 to 180 degrees in the drawing, in the recording area of the disc-shaped optical disc. On the other hand, by using the fifth, sixth, or seventh embodiment of the present invention, characters of “usable” or the like, for example, are deleted from the surface of the recording area at 180 to 360 degrees.

Incidentally, a user has an illusion in which transparent characters are changed, because of the disc-shaped optical disc.

In addition, as a combination of making such characters or the like emerge and deleting them, it is possible to use tracks in odd numbers to make characters or the like emerge, and to use tracks in even numbers to delete the characters or the like, for example. Alternatively, in the case of a multilayer disc, it is possible to use one recording layer to make characters or the like emerge, and to use another recording layer to delete the characters or the like, for example. In addition, in the case of the multilayer disc, it can be also constructed such that the characters or the like are made emerge and deleted in each layer.

### Ninth Embodiment

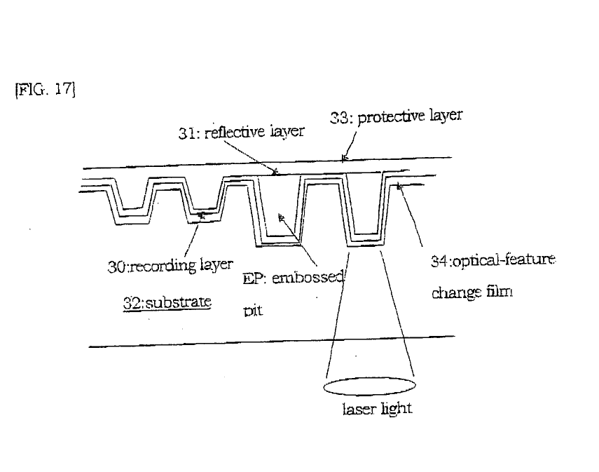

Next, with reference to FIG. 17, a detailed explanation will be given for the physical structure of an optical disc in a ninth embodiment of the present invention FIG. 17 is a schematic enlarged view showing the cross section of the optical disc in the ninth embodiment of the present invention. Incidentally, the outline of a relative positional relationship or the like in the upper part and the lower part shown in FIG. 17 is the same as that in FIG. 3 and FIG. 4 or the like.

The optical disc 100 in the ninth embodiment of the present invention has substantially the same basic physical features and structure as in the first to eighth embodiments.

In particular, according to the ninth embodiment, an optical-feature change film 34 whose transmittance is changed with a predetermined power of the laser light is laminated, in a predetermined display pattern designed, on the embossed pit BP or the record mark 20, which constitutes the optical record information. The optical-feature change film 34 is laminated with a mask when the optical disc is prepared. According to this optical disc, if it is formed of a pigment film considering the wavelength of the laser for reproduction, because it is irradiated with the laser for reproduction, the optical disc is de-pigmented and becomes transparent, so that its transmittance increases. On the other hand, because it is irradiated with the laser for reproduction, the optical disc is pigmented by photoreaction, so that its transmittance decreases. As described above, the optical-feature change film 34 is laminated on the embossed pit EP or the record mark 20 in the predetermined pattern, so that the visible display pattern designed in advance is displayed or deleted by reproducing it by a predetermined number of times of reproduction.

### Tenth Embodiment

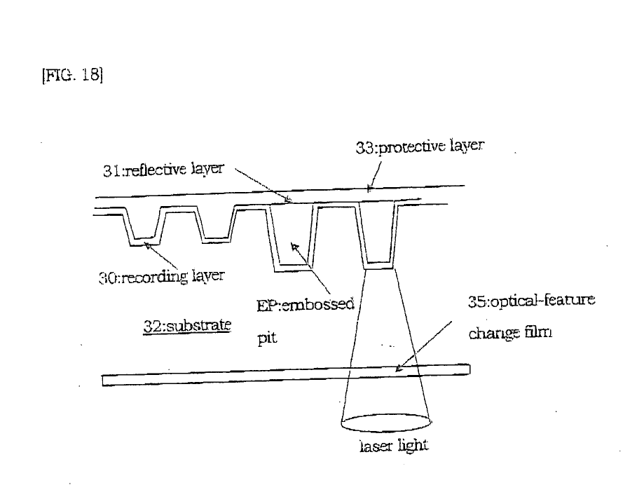

Next, with reference to FIG. 18, a detailed explanation will be given for the physical structure of an optical disc in a tenth embodiment of the present invention. FIG. 18 is a schematic enlarged view showing the cross section of the optical disc in the tenth embodiment of the present invention. Incidentally, the outline of a relative positional relationship or the like in the upper part and the lower part shown in FIG. 18 is the same as that in FIG. 3 and FIG. 4 or the like.

The optical disc 100 in the tenth embodiment of the present invention has substantially the same basic physical features and structure as in the first to ninth embodiments.

In particular, according to the tenth embodiment, an optical-feature change film 35 whose transmittance is changed with a predetermined power of the laser light is laminated, in a predetermined display pattern designed, on the opposite side of where there is the embossed pit EP or the record mark 20, which constitutes the optical record information, across the substrate 32, i.e., on the lower side in FIG. 18. The optical-feature change fix 35 can be realized by disposing a mask with the predetermined pattern designed, on the plane on the reading side of the optical disc which is finished through normal manufacturing processes, and by applying a pigment film whose transmittance is changed in optical conditions, such as a predetermined power of the laser light. Incidentally, there is a difference in the boundary of the mask; and an error corrected rate is reduced, so that the data is desirably not located in this boundary portion. More specifically, contents are recorded on the inner circumferential side and the transparent pigment film is formed on the outer circumferential side with a radial width of 5 mm so as to display characters. Then, the color of the pigment film, or its transmittance, may be changed by irradiating the laser for reproduction.

Incidentally, the optical-feature change films 34 and 35 in the ninth and tenth embodiments may be constructed to have a reversible character. More specifically, in the case of materials such as polymer, the bonding condition of atoms is changed by irradiating light with different wavelengths, so that color appears or it becomes transparent. By using the materials for the optical-feature change films 34 and 35 in the ninth and tenth embodiments, it is possible to use the same optical disc, repeatedly.

(Information Reproducing Apparatus)

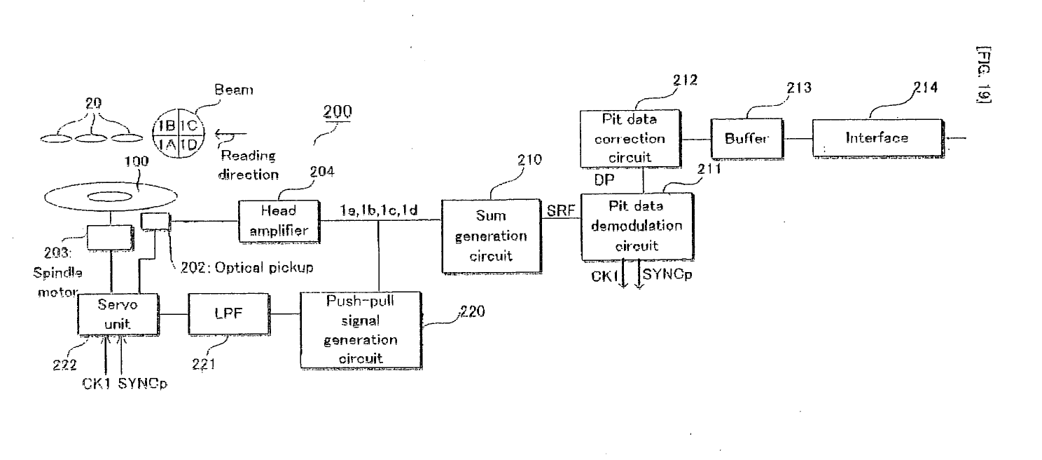

Next, with reference to FIG. 19, an information reproducing apparatus for the optical disc in the embodiments of the present invention will be discussed. FIG. 19 is a block diagram showing the entire structure of an information reproducing apparatus 200 for the optical disc, in an embodiment of the present invention.

The information reproducing apparatus 200 is provided with: the optical disc 100; an optical pickup 202; a spindle motor 203; a head amplifier 204; a sum generation circuit 210; a pit data demodulation circuit 211; a pit data correction circuit 212; a buffer 213; an interface 214; a push-pull signal generation circuit 220; a low pass filter 221; and a servo unit 222.

On the optical disc 100, pit data DP synchronized with a first clock signal CK1 is recorded by the length of the record mark 20. The first clock signal CK1 of a RF reproduction signal component is a signal which can be generated by the information reproducing apparatus 200 from the RF reproduction signal component of the optical disc 100 which varies in an almost constant cycle, in accordance with the wobbling, an unreadable emboss, or the like, as explained in the various embodiments of the optical disc 100 described above. In this embodiment, the first clock signal CK1 is generated by the pit data demodulation circuit 211. Incidentally, in the embodiment, the record mark 20 can be interpreted as a pit, and the track is constructed from this pit row.

More specifically, the information reproducing apparatus 200 is provided with: the optical pickup 202 for irradiating the optical disc 100 with a reproduction beam and outputting a signal in response to reflected light; the spindle motor 203 for controlling the rotation of the optical disc 100; and the servo unit 222. The first clock signal CK1 and a pit synchronization signal SYNCP are supplied to the servo unit 222. The servo unit 222 is synchronized with these signals, and performs spindle servo for controlling the rotation of the spindle motor 203, and focus servo and tracking servo for performing relative position control of the optical pickup 202 to the optical disc 100.

The optical pickup 202 is provided with a laser diode for irradiating the reproduction beam; and a not-illustrated four-division detection circuit. The four-division detection circuit divides the reflected light of the reproduction beam into four areas 1A, 1B, 1C, and 1D shown in the upper part of FIG. 19, and outputs each signal corresponding to the quantity of light in respective one of the areas. The head amplifier 204 amplifies each output signal of the optical pickup 202, and outputs a divisional read signal 1a corresponding to the area 1A, a divisional read signal 1b corresponding to the area 1B, a divisional read signal 1c corresponding to the area 1C, and a divisional read signal 1d corresponding to the area 1D.

The sum generation circuit 210 is provided with an addition circuit for adding the divisional read signals 1a, 1b, 1c, and 1d and for outputting a sum read signal SRF. Incidentally, the sum read signal SRF is a signal which represents the length of the record mark.

The pit data demodulation circuit 211 reproduces the pit data DP on the basis of the sum read signal SRF, and generates the first clock signal CK1. More specifically, the pit data demodulation circuit 211 demodulates the reproduced pit data DP by using a predetermined table, with the pit synchronization signal SYNCp as a reference position, to thereby generate reproduction data. For example, if EFM modulation is adopted as a modulating method, a process of converting 14-bit pit data DP to 8-bit reproduction data is performed. Then, a descramble process is performed in which the order of the reproduction data is rearranged in accordance with a predetermined rule, and the processed reproduction data is outputted.

The reproduction data obtained in this manner is supplied to the pit data correction circuit 212, on which an error correction process and an interpolation process are performed, and then, it is stored into the buffer 213. The interface 214 sequentially reads the data stored in the buffer 213, converts it in a predetermined output format, and outputs it to external equipment.

The push-pull signal generation circuit 220 calculates (1a+1d)−(1b+1c) and generates a push-pull signal. The component (1a+1d) corresponds to the areas 1A and 1D which are on the left side with respect to the reading direction, while the component (1b+1c) corresponds to the areas 1B and 1C which are on the right side with respect to the reading direction. The value of the push-pull signal indicates a relative position relationship between the reproduction beam and the track.

The push-pull signal is outputted to the servo unit 222 through the low pass filter 221. The servo unit 222 performs the tracking control on the basis of the push-pull signal.

The present invention is not limited to the above-described embodiments, and various changes may be made, if desired, without departing from the essence or spirit of the invention which can be read from the claims and the entire specification. An information recording medium which involves, such change, is also intended to be within the technical scope of the present invention.

### INDUSTRIAL APPLICABILITY

The information recording medium of the present invention can be applied to an optical disc on which recording and reproduction can be performed by irradiating it with laser light, for example.

1-17. (canceled)

18. An information recording medium comprising:
a substrate and
a recording layer which is laminated on the substrate and whose optical feature is changed by being irradiated, with laser light, to thereby display or delete a visible display pattern,
out of (i) a reproduce-only area in which first record information is recorded not to be unreproducible along with a reproduction operation and (ii) a reproduction frequency limited area in which second record information is recorded to be unreproducible along with a predetermined number of times of reproduction operations,
the recording layer being formed at least in accordance with the reproduction frequency limited area.

19. The information recording medium according to claim 18, wherein (i) the second record information is recorded into the reproduction frequency limited area by forming a record mark corresponding to the second record information, and (ii) the second record information is deleted from the reproduction frequency limited area by deleting the record mark along with the predetermined number of times of reproduction operations, and at least one of the substrate and the recording layer is formed (iii) such that a visible display pattern can be made from a difference in the optical feature between an area in which the record mark is deleted and an area in which the record mark has been absent since before the reproduction operation, in such a condition that the record mark is deleted, or (iv) such that a visible display pattern can be made from a difference in the optical feature between an area in which the record mark is present and an area in which the record mark has been absent since before the reproduction operation, in such a condition that the record mark is present.

20. The information recording medium according to claim 19, wherein at least one of the substrate and the recording layer is formed (i) such that the visible display pattern can be made from the difference in the optical feature between the reproduction frequency limited area in which the record mark is deleted and the reproduce-only area, in such a condition that the record mark is deleted, or (ii) such that the visible display pattern can be made from the difference in the optical feature between the reproduction frequency limited area in which the record mark is present and the reproduce-only area, in such a condition that the record mark is present.

21. The information recording medium according to claim 19, wherein the recording layer is formed in the reproduce-only area such that the optical feature is changed or not changed along with the reproduction operation of reproducing the first record information.

22. The information recording medium according to claim 19, wherein at least one of the substrate and the recording layer is at least partially formed (i) such that the visible display pattern can be made from the difference in the optical feature in such a condition that the record mark is deleted along with the predetermined. number of times of reproduction operations, and (ii) such that the visible display pattern can not be made from the difference in the optical feature in such a condition that the record mark is present.

23. The information recording medium according to claim 19, wherein at least one of the substrate and the recording layer is at least partially formed (i) such that the visible display pattern can be made from the difference in the optical feature in such a condition that the record mark is present, and (ii) such that the visible display pattern can not be made from the difference in the optical feature in such a condition that the record mark is deleted along with the predetermined number of times of reproduction operations.

24. The information recording medium according to claim 19, wherein the optical feature is optical reflectance ratio.

25. The information recording medium according to claim 19, wherein the optical feature is refractive index.

26. The information recording medium according to claim 19, wherein a concavo-convex pattern which generates the difference in the optical feature is formed on a surface of the substrate.

27. The information recording medium according to claim 19, wherein the visible display pattern includes characters or figures.

28. The information recording medium according to claim 19, wherein reproduction control information necessary to reproduce the first record information recorded in the reproduce-only area is recorded in the reproduction frequency limited area, as the second record information.

29. The information recording medium according to claim 19, wherein the first record information is recorded in the reproduce-only area (i) such that the first record information can be reproduced by irradiating laser for reproduction as the reproduction operation and (ii) such that the first record information is not deleted and the second record information is recorded in the reproduction frequency limited area (iii) such that the second record information can be reproduced by the predetermined number of times by irradiating the laser for reproduction as the reproduction operation and (iv) such that the second record information is deleted by irradiating the laser for reproduction by the predetermined number of times.

30. The information recording medium according to claim 29 wherein the second record information can be recorded by irradiating laser for recording, in the reproduction frequency limited area.

31. The information recording medium according to claim 29, wherein the recording layer has such a recording feature that a reproduction power range in which the second record information can be reproduced, at least partially overlaps with a deleting power range in which the second record information can be deleted.

32. The information recording medium according to claim 19, wherein (i) the recording layer includes a recording layer of such a type that it is phase changed between an amorphous state and a crystalline state, and (ii) the optical feature is at least partially defined from an area ratio between an area in which the recording layer is in the amorphous state and an area in which the recording layer is in the crystalline state, in at least one of the reproduce-only area and the reproduction frequency limited area.

33. The information recording medium according to claim 19, wherein (i) the recording layer includes a recording layer of such a type that it is phase changed between an amorphous state and a crystalline state, and (ii) the optical feature is at least partially defined from a phase change ratio of a recording layer, in at least one of the reproduce-only area and the reproduction frequency limited area.
